(19) United States
(12) Patent Application Publication
(10) Pub. No.: US 2024/0224165 A1
(43) Pub. Date: Jul. 4, 2024

(54) AUTOMATIC GROUPING OF DEPLOYED ACCESS POINTS

(71) Applicant: Juniper Networks, Inc., Sunnyvale, CA (US)

(72) Inventors: Mohammad Zohoorian, San Francisco, CA (US); Nagarjun Srinivasan, Sunnyvale, CA (US); Christopher Wesley Wright, Scotts Valley, CA (US)

(21) Appl. No.: 18/400,515

(22) Filed: Dec. 29, 2023

Related U.S. Application Data
(60) Provisional application No. 63/478,025, filed on Dec. 30, 2022.

(51) Int. Cl. H04W 48/16; H04W 48/08

(52) U.S. Cl. CPC H04W 48/16; H04W 48/08

(57) ABSTRACT

The disclosure describes a system comprising a plurality of APs configured to provide a wireless network at a site and a computing device that implements a network management system (NMS) that manages the plurality of APs, the computing device comprising: one or more processors and a memory comprising instructions that when executed by the one or more processors, cause the one or more processors to: obtain network data indicative of communication relationships between the plurality of APs; generate, based on the network data, a network graph indicative of neighbor relationships between the plurality of APs; group the plurality of APs into a plurality of clusters of APs based on the neighbor relationships between the plurality of APs; and uniquely assign, to each of the plurality of clusters, an identifier of a plurality of identifiers indicative of a cluster of the plurality of clusters with respect to the site.

### PRIORITY

This application claims the benefit of U.S. Provisional Patent Application No. 63/478,025, filed Dec. 30, 2022, the entire contents of which is incorporated herein by reference.

### FIELD

The disclosure relates generally to computer networks and, more specifically, to automated deployment and monitoring of wireless networks.

### BACKGROUND

Commercial premises, such as offices, hospitals, airports, stadiums, or retail outlets, often include a network of wireless access points (APs) installed throughout the premises to provide wireless network services to one or more wireless client devices. APs enable client devices to wirelessly connect to a wired network using various wireless networking protocols and technologies, such as wireless local area networking protocols conforming to one or more of the IEEE 802.11 standards (i.e., “Wi-Fi”), Bluetooth/Bluetooth Low Energy (BLE), mesh networking protocols such as ZigBee or other wireless networking technologies. Many different types of wireless client devices, such as laptop computers, smartphones, tablets, wearable devices, appliances, and Internet of Things (IoT) devices, incorporate wireless communication technology and can be configured to connect to wireless access points when the device is in range of a compatible wireless access point in order to access a wired network. Location services that may be provided in conjunction with a wireless network include wayfinding, location-based proximity notifications, asset tracking, and location-based analytics that derive insights from client mobility through the premises.

### SUMMARY

In general, the disclosure describes techniques for automatically grouping one or more deployed access points (APs) in a wireless network that is used to learn the wireless network environment. Wireless network systems (e.g., Wi-Fi systems) are often deployed in high-rise or other buildings spanning multiple floors. When wireless network systems are deployed in such environments, multiple groups of technicians may install a plurality of APs on the various floors to provide one or more wireless networks throughout the multi-floor structure. The one or more deployed APs may be grouped, for example, based on the particular floor of a multi-floor structure of a site and/or based on a particular building of a multi-building site. For example, the floor information of a group of APs (otherwise referred to herein as “cluster of APs”) may include, for example, a specific floor number of a multi-floor structure on which the group of APs is installed. The floor information may be used to determine location of the deployed APs and to learn and optimize the wireless network environment provided by the wireless network. Typically, during the installation, the installers manually determine and enter the group information (e.g., specific floor number and/or building information) for the deployed APs. However, manually determining and entering group information for APs into a database is prone to error and is time-consuming. The techniques described in this disclosure may provide automatic grouping of one or more deployed APs in a wireless network that is used to learn the wireless network environment.

In one example, a network management system (NMS) that manages wireless networks of one or more sites is configured to generate a network graph for a plurality of APs deployed at the site that represents the neighbor relationship between the deployed APs. The neighbor relationships between deployed APs may be based on detected radio signals of the APs. The NMS is configured to generate a matrix representation of the network graph and apply a clustering algorithm to the matrix representation of the network graph to form groups of APs. For instance, the NMS may generate a network graph for the plurality of deployed APs based on received signal strength indicator (RSSI) values (of Wi-Fi signals, Bluetooth signals, or other radio signals), where nodes in the network graph represent the APs and connectivity of the nodes within the network graph may represent a communication relationship between the APs. The network graph may be represented by a Laplacian matrix (L), where the Laplacian matrix is the difference between a degree matrix (D) (e.g., a diagonal matrix that contains information of the degree of each node (i.e., vertex) in the network graph) and an adjacency matrix (A) that contains information of the adjacency of nodes in the network graph (e.g., L=D−A). The NMS may apply a spectral clustering algorithm (e.g., k-means clustering algorithm) to eigenvalues and eigenvectors of the Laplacian matrix of the network graph to form clusters of APs where each cluster may represent APs deployed on the same floor of the multi-floor structure (or in the same building or section of a multi-building site). For example, the NMS may form clusters based on the density of communication between nodes of the network graph and/or how the nodes are connected. Based on the clusters of APs, the NMS may determine the location (e.g., x, y coordinates) of the APs (e.g., the placement of the APs on a map), which in turn is used to learn and optimize the wireless network environment provided by the wireless network.

The techniques of the disclosure provide one or more technical advantages and practical applications. For example, automatic grouping of one or more deployed APs can reduce costs and increase efficiency as compared to the time-consuming and error-prone manual process of determining and entering a list of APs belonging to each group of APs to set up a wireless network. Significant labor savings can be realized as technicians need not manually determine and enter group information for deployed APs into a database at the time of installation. The techniques also use the automatic grouping of deployed APs to facilitate automated localization and floor determination of APs, thus reducing the need to dispatch technicians to conduct periodic manual site surveys in order to keep the floor information up to date, which may be used for rapid and dynamic deployment and provisioning of wireless networks (e.g., automatically detecting when an AP has been removed, one or more APs have been moved to a different floor of the multi-floor structure, or a new AP has been installed), to provision highly precise indoor location-based services at a site, which depend upon accurate knowledge of the floor number on which each AP is installed. The techniques further use the automatic grouping of deployed APs for radio frequency (RF) coverage optimization and radio resource management of the APs at the site, such as channel and transmit power level selection, thus supporting optimization of network performance and improving the overall user experience of the wireless network.

In one example, the disclosure is directed to a system comprising: a plurality of access point devices (APs) configured to provide a wireless network at a site; and a computing device implementing a network management system (NMS) that manages the plurality of APs, the computing device comprising: one or more processors: a memory comprising instructions that when executed by the one or more processors, cause the one or more processors to: obtain network data indicative of communication relationships between the plurality of APs; generate, based on the network data, a network graph; group, based on the network graph, the plurality of APs into a plurality of clusters of APs; and uniquely assign, to each of the plurality of clusters, an identifier of a plurality of identifiers that is indicative of a cluster of the plurality of clusters with respect to the site.

In another example, the disclosure is directed to a method comprising: obtaining, by a computing device implementing a network management system (NMS) that manages a plurality of access point devices (APs) configured to provide a wireless network at a site, network data indicative of communication relationships between the plurality of APs; generating, by the computing device and based on the network data, a network graph; grouping, by the computing device and based on the network graph, the plurality of APs into a plurality of clusters of APs; and uniquely assigning, by the computing device and to each of the plurality of clusters, an identifier of a plurality of identifiers that is indicative of a cluster of the plurality of clusters with respect to the site.

In another example, the disclosure describes to a non-transitory computer readable medium comprising instructions that when executed by one or more processors cause the one or more processors to: obtain network data indicative of communication relationships between a plurality of access point devices (APs) configured to provide a wireless network at a site; generate, based on the network data, a network graph; group, based on the network graph, the plurality of APs into a plurality of clusters of APs; and uniquely assign, to each of the plurality of clusters, an identifier of a plurality of identifiers that is indicative of a cluster of the plurality of clusters with respect to the site.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1A is a diagram of an example network system 100 that automatically groups one or more deployed access points (APs) of the deployed APs that is used to learn the wireless network environment, in accordance with one or more techniques of the disclosure.

FIG. 1B is a block diagram illustrating further example details of the network system of FIG. 1A.

FIG. 2 is a block diagram of an example access point device, in accordance with one or more techniques of the disclosure.

FIG. 3A is a block diagram of an example network management system configured to automatically group one or more deployed APs that is used to learn the wireless network environment, in accordance with one or more techniques of the disclosure.

FIG. 3B is a block diagram of an example AP grouping module configured to automatically group one or more deployed APs that is used to learn the wireless network environment, in accordance with one or more techniques of the disclosure.

FIG. 4 is a block diagram of an example user equipment device in accordance with one or more techniques of the disclosure.

FIG. 5 is a block diagram of an example network node, such as a router or switch, in accordance with one or more techniques of the disclosure.

FIGS. 6A-6B show a conceptual diagram illustrating an example grouping of one or more deployed APs that is used to learn the wireless network environment, in accordance with one or more techniques of the disclosure.

FIG. 7 is a conceptual diagram illustrating an example group map based on the automatic grouping of the one or more deployed APs, in accordance with one or more techniques of the disclosure.

FIGS. 8A-8B illustrate other examples of automatically grouping one or more deployed access points (APs) in a wireless network, in accordance with the techniques described in this disclosure.

FIG. 9 is a flowchart of example process by which a network management system automatically groups one or more deployed APs that is used to learn the wireless network environment, in accordance with one or more techniques of the disclosure.

### DETAILED DESCRIPTION

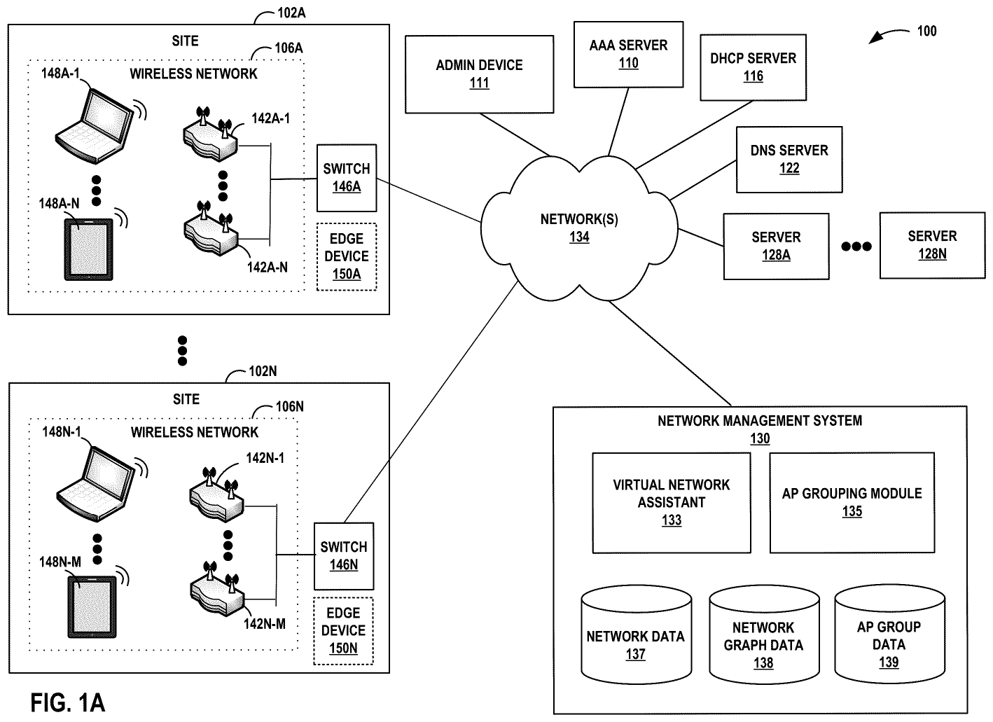

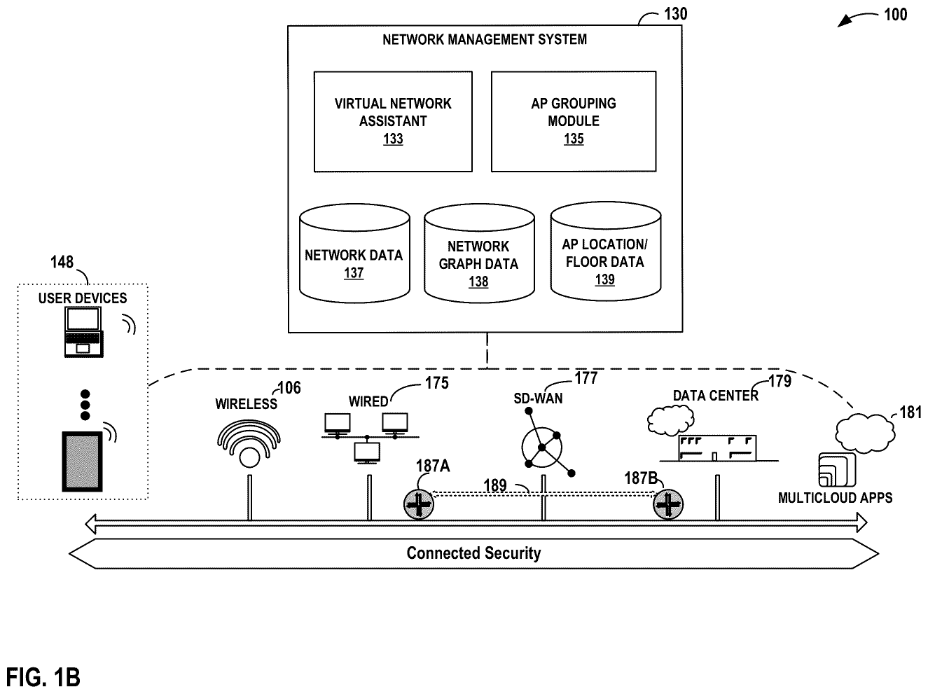

FIG. 1A is a diagram of an example network system 100 in which a network management system (NMS) 130 automatically groups one or more deployed access points (APs) in a wireless network that is used to learn the wireless network environment. Example network system 100 includes a plurality sites 102A-102N at which a network service provider manages one or more wireless networks 106A-106N, respectively. Although in FIG. 1A each site 102A-102N is shown as including a single wireless network 106A-106N, respectively, in some examples, each site 102A-102N may include multiple wireless networks, and the disclosure is not limited in this respect. In addition, although the examples will be described herein with respect to determining group(s) of APs, the techniques described herein may also be applied to determining group information of any type of computing devices in a wired or wireless network.

Each site 102A-102N includes a plurality of network access server (NAS) devices, such as access points (APs) 142, switches 146, or routers (not shown). For example, site 102A includes a plurality of APs 142A-1 through 142A-N. Similarly, site 102N includes a plurality of APs 142N-1 through 142N-M. Each AP 142 may be any type of wireless access point, including, but not limited to, a commercial or enterprise AP, a router, or any other device that is connected to a wired network and is capable of providing wireless network access to client devices within the site. For purposes of the present disclosure, a plurality of APs 142 are deployed on multiple floors of a building or other structure, or across multiple buildings or other structure, to establish a wireless network at a site 102.

Each site 102A-102N also includes a plurality of client devices, otherwise known as user equipment devices (UEs), referred to generally as UEs or client devices 148, representing various wireless-enabled devices within each site. For example, a plurality of UEs 148A-1 through 148A-N are currently located at site 102A. Similarly, a plurality of UEs 148N-1 through 148N-M are currently located at site 102N. Each UE 148 may be any type of wireless client device, including, but not limited to, a mobile device such as a smart phone, tablet or laptop computer, a personal digital assistant (PDA), a wireless terminal, a smart watch, smart ring, or other wearable device. UEs 148 may also include wired client-side devices, e.g., IoT devices such as printers, security devices, environmental sensors, or any other device connected to the wired network and configured to communicate over one or more wireless networks 106. References to “N” or “M” may represent any number. References to “N” for different elements need not be the same number. Similarly, references to “M” for different elements need not be the same number.

In order to provide wireless network services to UEs 148 and/or communicate over the wireless networks 106, APs 142 and the other wired client-side devices at sites 102 are connected, either directly or indirectly, to one or more network devices (e.g., switches, routers, or the like) via physical cables, e.g., Ethernet cables. In the example of FIG. 1A, site 102A includes a switch 146A to which each of APs 142A-1 through 142A-N at site 102A are connected. Similarly, site 102N includes a switch 146N to which each of APs 142N-1 through 142N-M at site 102N are connected. Although illustrated in FIG. 1A as if each site 102 includes a single switch 146 and all APs 142 of the given site 102 are connected to the single switch 146, in other examples, each site 102 may include more or fewer switches and/or routers. In addition, the APs and the other wired client-side devices of the given site may be connected to two or more switches and/or routers. In addition, two or more switches at a site may be connected to each other and/or connected to two or more routers, e.g., via a mesh or partial mesh topology in a hub-and-spoke architecture. In some examples, interconnected switches and routers comprise wired local area networks (LANs) at sites 102 hosting wireless networks 106.

Example network system 100 also includes various networking components for providing networking services within the wired network including, as examples, an Authentication, Authorization and Accounting (AAA) server 110 for authenticating users and/or UEs 148, a Dynamic Host Configuration Protocol (DHCP) server 116 for dynamically assigning network addresses (e.g., IP addresses) to UEs 148 upon authentication, a Domain Name System (DNS) server 122 for resolving domain names into network addresses, a plurality of servers 128A-128N (collectively “servers 128”) (e.g., web servers, databases servers, file servers and the like), and a network management system (NMS) 130. As shown in FIG. 1A, the various devices and systems of network 100 are coupled together via one or more network(s) 134, e.g., the Internet and/or an enterprise intranet.

In the example of FIG. 1A, NMS 130 is a cloud-based computing platform that manages wireless networks 106A-106N at one or more of sites 102A-102N. As further described herein, NMS 130 provides an integrated suite of wireless network management tools and implements various techniques of the disclosure. In general, NMS 130 may provide a cloud-based platform for wireless network data acquisition, monitoring, activity logging, reporting, predictive analytics, network anomaly identification, and alert generation. In some examples, NMS 130 uses a combination of artificial intelligence, machine learning, and data science techniques to optimize user experiences and simplify operations across any one or more of wireless access, wired access, and SD-WAN domains. In some examples, NMS 130 outputs notifications, such as alerts, alarms, graphical indicators on dashboards, log messages, text/short messaging service (SMS) messages, email messages, and the like, and/or recommendations regarding wireless network issues to a site or network administrator (“admin”) interacting with and/or operating admin/device 111. Additionally, in some examples, NMS 130 operates in response to configuration input received from the administrator interacting with and/or operating admin device 111.

The administrator and admin device 111 may comprise IT personnel and an administrator computing device associated with one or more of sites 102. Admin device 111 may be implemented as any suitable device for presenting output and/or accepting user input. For instance, admin device 111 may include a display. Admin device 111 may be a computing system, such as a mobile or non-mobile computing device operated by a user and/or by the administrator. Admin device 111 may, for example, represent a workstation, a laptop or notebook computer, a desktop computer, a tablet computer, or any other computing device that may be operated by a user and/or present a user interface in accordance with one or more aspects of the present disclosure. Admin device 111 may be physically separate from and/or in a different location than NMS 130 such that admin device 111 may communicate with NMS 130 via network 134 or other means of communication.

In some examples, one or more of the NAS devices, e.g., APs 142, switches 146, or routers, may connect to corresponding edge devices 150A-150N via physical cables, e.g., Ethernet cables. Edge devices 150 comprise cloud-managed, wireless local area network (LAN) controllers. Each of edge devices 150 may comprise an on-premises device at a site 102 that is in communication with NMS 130 to extend certain microservices from NMS 130 to the on-premises NAS devices while using NMS 130 and its distributed software architecture for scalable and resilient operations, management, troubleshooting, and analytics.

Each one of the network devices of network system 100, e.g., servers 110, 116, 122 and/or 128, APs 142, UEs 148, switches 146, and any other servers or devices attached to or forming part of network system 100, may include a system log or an error log module wherein each one of these network devices records the status of the network device including normal operational status and error conditions. Throughout this disclosure, one or more of the network devices of network system 100, e.g., servers 110, 116, 122 and/or 128, APs 142, UEs 148, and switches 146, may be considered “third-party” network devices when owned by and/or associated with a different entity than NMS 130 such that NMS 130 does not receive, collect, or otherwise have access to the recorded status and other data of the third-party network devices. In some examples, edge devices 150 may provide a proxy through which the recorded status and other data of the third-party network devices may be reported to NMS 130.

In some examples, NMS 130 monitors network data 137 (e.g., one or more service level expectation (SLE) metrics, signal strength measurements, device measurements, etc.) received from wireless networks 106A-106N at each site 102A-102N, respectively, and manages network resources, such as APs 142 at each site, to deliver a high-quality wireless experience to end users, IoT devices and clients at the site. For example, NMS 130 may include a virtual network assistant (VNA) 133 that implements an event processing platform for providing real-time insights and simplified troubleshooting for IT operations, and that automatically takes corrective action or provides recommendations to proactively address wireless network issues. VNA 133 may, for example, include an event processing platform configured to process hundreds or thousands of concurrent streams of network data 137 from sensors and/or agents associated with APs 142 and/or nodes within network 134. For example, VNA 133 of NMS 130 may include an underlying analytics and network error identification engine and alerting system in accordance with various examples described herein. The underlying analytics engine of VNA 133 may apply historical data and models to the inbound event streams to compute assertions, such as identified anomalies or predicted occurrences of events constituting network error conditions. Further, VNA 133 may provide real-time alerting and reporting to notify a site or network administrator via admin device 111 of any predicted events, anomalies, trends, and may perform root cause analysis and automated or assisted error remediation. In some examples, VNA 133 of NMS 130 may apply machine learning techniques to identify the root cause of error conditions detected or predicted from the streams of network data 137. If the root cause may be automatically resolved, VNA 133 may invoke one or more corrective actions to correct the root cause of the error condition, thus automatically improving the underlying SLE metrics and also automatically improving the user experience.

Further example details of operations implemented by the VNA 133 of NMS 130 are described in U.S. Pat. No. 9,832,082, issued Nov. 28, 2017, and entitled “Monitoring Wireless Access Point Events,” U.S. Publication No. US 2021/0306201, published Sep. 30, 2021, and entitled “Network System Fault Resolution Using a Machine Learning Model,” U.S. Pat. No. 10,985,969, issued Apr. 20, 2021, and entitled “Systems and Methods for a Virtual Network Assistant,” U.S. Pat. No. 10,958,585, issued Mar. 23, 2021, and entitled “Methods and Apparatus for Facilitating Fault Detection and/or Predictive Fault Detection,” U.S. Pat. No. 10,958,537, issued Mar. 23, 2021, and entitled “Method for Spatio-Temporal Modeling,” and U.S. Pat. No. 10,862,742, issued Dec. 8, 2020, and entitled “Method for Conveying AP Error Codes Over BLE Advertisements,” all of which are incorporated herein by reference in their entirety.

NMS 130 observes, collects and/or receives network data 137 for a variety of client devices, such as SDK clients, named assets, and/or client devices connected/unconnected to the wireless network. The network data may include a plurality of states or parameters indicative of one or more aspects of wireless network performance. Network data 137 may take the form of data extracted from messages, counters, and statistics, for example. The network data may be collected and/or measured by one or more UEs 148 and/or one or more AP devices 142 in a wireless network 106. Some of the network data 137 may be collected and/or measured by other devices in the network system 100, such as switches or firewalls. The network data may be stored in a database, such as network data 137 within NMS 130 or, alternatively, in an external database.

In accordance with one specific implementation, a computing device is part of NMS 130. In accordance with other implementations, NMS 130 may comprise one or more computing devices, dedicated servers, virtual machines, containers, services, or other forms of environments for performing the techniques described herein. Similarly, computational resources and components implementing VNA 133 may be part of the NMS 130, may execute on other servers or execution environments, or may be distributed to nodes within network 134 (e.g., routers, switches, controllers, gateways, and the like).

In accordance with the techniques described in this disclosure, NMS 130 is configured to automatically group one or more deployed APs in a wireless network that is used to learn the wireless network environment. A plurality of APs may be deployed (e.g., installed) on a plurality of floors of a multi-floor building or structure (or deployed across a plurality of buildings) to establish a wireless network at a site, e.g., APs 142A-1 through 142A-N deployed at site 102A. NMS 130 includes an AP grouping module 135 that is configured to automatically group one or more APs (e.g., APs 142A) and uniquely assign an identifier to each of the groups of APs that indicate the location of the groups of APs with respect to site 102A.

For example, NMS 130 may obtain information of detected radio signals (e.g., RSSI values) from a plurality of APs (e.g., APs 142) (or any other device that is capable of providing wireless network access to client devices within the site) and based on the RSSI values, AP grouping module 135 generates a graph-based representation of the plurality of APs (also referred to herein as a “network graph” or “neighbor graph”) that represents connection relationships between the plurality of APs (i.e., the neighbor relationships between the plurality of APs). An RSSI value may represent the strength of a radio signal (e.g., decibels relative to milliwatt (dBm)) received by an AP, such as the strength of a Wi-Fi signal, a short-range wireless signal (e.g., Bluetooth signal), or any other radio signal. Nodes of the network graph may represent the APs and each connection between the nodes in the network graph may represent the APs that can detect a radio signal (or detect a radio signal of a certain signal strength) from other APs. For example, each connection between nodes in the graph may represent the connected APs have detected a radio signal from each other. In some examples, network system 100 may include a large number of connections between APs 142 (e.g., an AP may detect more than 10 other APs). In these examples, AP grouping module 135 may filter the network graph of APs 142 to include the APs with strongest connectivity to reduce the number of connections between APs within the network graph and thus use a smaller data set of APs. For example, AP 142A-N may detect radio signals from ten other APs within site 102A. In this example, AP grouping module 135 may apply an RSSI threshold (e.g., −70 dBm) to filter the network graph of APs 142 to include a subset of the ten other APs, such as two APs of the ten APs that represent the APs with the strongest connectivity (e.g., filter out connections between to APs that have less than −70 dBm). In some examples, an administrator may specify, via admin device 111, the RSSI threshold. In some examples, the network graph of APs 142 is based on a mean of RSSI values between APs over a period of time. Additional examples of the network graph are described in U.S. application Ser. No. 17/804,780, filed May 31, 2022, and entitled “Automatic Upgrade Planning,” the entire contents of which is incorporated by reference herein.

In response to generating the network graph of APs, AP grouping module 135 may generate a matrix representation of the network graph of APs. For example, AP grouping module 135 may generate a Laplacian matrix (L) that represents the network graph of APs, where the Laplacian matrix is the difference between: (1) a degree matrix (D) that is a diagonal matrix specifying information of the degree of each node (e.g., number of edges incident to the node, which represents the number of connections of an AP to other APs), and (2) an adjacency matrix (A) that specifies information of the adjacency of the nodes in the network graph (e.g., information identifying which APs have connectivity).

In response to generating the Laplacian matrix that represents the network graph of APs, AP grouping module 135 may compute eigenvalues and eigenvectors based on the Laplacian matrix. An eigenvector is a vector that changes based on a scalar factor when a linear transformation is applied to the vector. The scalar factor by which an eigenvector is scaled is referred to as eigenvalue. The number of computed eigenvectors may be based on, for example, the number of desired clusters that represents the number of floors of the multi-floor structure (or number of buildings or sections of a multi-building site). As further described below, AP grouping module 135 may apply a spectral clustering algorithm (e.g., k-means clustering algorithm) to eigenvalues and eigenvectors of the Laplacian matrix of the network graph to form clusters of one or more APs. The value “k” may be based on, for example, the number of floors of a multi-floor site or the number of buildings of a multi-building site. Each of the resulting clusters output by the k-means clustering algorithm may represent, for example, a densely populated area of APs that have a strong connection to each other, and thus may represent a group of APs of a particular floor of a multi-floor structure (or a particular building or section of a multi-building site). The output by the k-means clustering algorithm may uniquely assign an identifier indicative of a cluster of APs with respect to a site (e.g., a specific floor number of a plurality of floor numbers on which the cluster of APs are installed).

AP grouping module 135 may store the network graph data in a database or other storage media, such as network graph data 138, for further monitoring and/or analysis. Network graph data 138 may include values of the Laplacian matrix that represents the network graph of APs, and/or the eigenvalues and eigenvectors computed from the Laplacian matrix representing the network graph of APs. AP grouping module 135 may also store the resulting group information (e.g., unique assignments to groups of APs) for each group of APs in a database or other storage media, such as AP group data 139, for further monitoring and/or analysis, such as for determining the location of APs of each group of APs.

In addition, NMS 130 may automatically generate one or more notifications and/or automatically invoke one or more actions based on identifier assigned for the group(s) of APs (e.g., floor number). In another example, the identifier assigned for the group(s) of APs (e.g., floor number) may be used to provide location services for client devices associated with the wireless network.

FIG. 1B is a block diagram illustrating further example details of the network system of FIG. 1A. In this example, FIG. 1B illustrates NMS 130 configured to operate according to an artificial intelligence/machine-learning-based computing platform providing comprehensive automation, insight, and assurance (Wi-Fi Assurance, Wired Assurance and WAN assurance) spanning from wireless network 106 and wired LAN 175 networks at the network edge (far left of FIG. 1B) to cloud-based application services 181 hosted by computing resources within data centers 179 (far right of FIG. 1). NMS 130 includes a virtual network assistant 133, AP grouping module 135, network data 137, network graph data 138, and AP group data 139.

As described herein, NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. For example, network management system 130 may be configured to proactively monitor and adaptively configure network system 100 so as to provide self-driving capabilities. Moreover, VNA 133 includes a natural language processing engine to provide AI-driven support and troubleshooting, anomaly detection, AI-driven location services, and AI-drive RF optimization with reinforcement learning.

As illustrated in the example of FIG. 1B, AI-driven NMS 130 also provides configuration management, monitoring and automated oversight of software defined wide-area network (SD-WAN) 177, which operates as an intermediate network communicatively coupling wireless networks 106 and wired LANs 175 to data centers 179 and application services 181. In general, SD-WAN 177 provides seamless, secure, traffic-engineered connectivity between “spoke” routers 187A of edge wired networks 175 hosting wireless networks 106, such as branch or campus networks, to “hub” routers 187B further up the cloud stack toward cloud-based application services 181. SD-WAN 177 often operates and manages an overlay network on an underlying physical Wide-Area Network (WAN), which provides connectivity to geographically separate customer networks. In other words, SD-WAN 177 extends Software-Defined Networking (SDN) capabilities to a WAN and allows network(s) to decouple underlying physical network infrastructure from virtualized network infrastructure and applications such that the networks may be configured and managed in a flexible and scalable manner.

In some examples, underlying routers of SD-WAN 177 may implement a stateful, session-based routing scheme in which the routers 187A, 187B dynamically modify contents of original packet headers sourced by user devices 148 to steer traffic along selected paths, e.g., path 189, toward application services 181 without requiring use of tunnels and/or additional labels. In this way, routers 187A, 187B may be more efficient and scalable for large networks since the use of tunnel-less, session-based routing may enable routers 187A, 187B to achieve considerable network resources by obviating the need to perform encapsulation and decapsulation at tunnel endpoints. Moreover, in some examples, each router 187A, 187B may independently perform path selection and traffic engineering to control packet flows associated with each session without requiring use of a centralized SDN controller for path selection and label distribution. In some examples, routers 187A, 187B implement session-based routing as Secure Vector Routing (SVR), provided by Juniper Networks, Inc.

Additional information with respect to session-based routing and SVR is described in U.S. Pat. No. 9,729,439, entitled “COMPUTER NETWORK PACKET FLOW CONTROLLER,” and issued on Aug. 8, 2017; U.S. Pat. No. 9,729,682, entitled “NETWORK DEVICE AND METHOD FOR PROCESSING A SESSION USING A PACKET SIGNATURE,” and issued on Aug. 8, 2017; U.S. Pat. No. 9,762,485, entitled “NETWORK PACKET FLOW CONTROLLER WITH EXTENDED SESSION MANAGEMENT,” and issued on Sep. 12, 2017; U.S. Pat. No. 9,871,748, entitled “ROUTER WITH OPTIMIZED STATISTICAL FUNCTIONALITY,” and issued on Jan. 16, 2018; U.S. Pat. No. 9,985,883, entitled “NAME-BASED ROUTING SYSTEM AND METHOD,” and issued on May 29, 2018; U.S. Pat. No. 10,200,264, entitled “LINK STATUS MONITORING BASED ON PACKET LOSS DETECTION,” and issued on Feb. 5, 2019; U.S. Pat. No. 10,277,506, entitled “STATEFUL LOAD BALANCING IN A STATELESS NETWORK,” and issued on Apr. 30, 2019; U.S. Pat. No. 10,432,522, entitled “NETWORK PACKET FLOW CONTROLLER WITH EXTENDED SESSION MANAGEMENT,” and issued on Oct. 1, 2019; and U.S. Patent Application Publication No. 2020/0403890, entitled “IN-LINE PERFORMANCE MONITORING,” published on Dec. 24, 2020, each of which is incorporated by reference herein in its entirety.

In some examples, AI-driven NMS 130 may enable intent-based configuration and management of network system 100, including enabling construction, presentation, and execution of intent-driven workflows for configuring and managing devices associated with wireless networks 106, wired LAN networks 175, and/or SD-WAN 177. For example, declarative requirements express a desired configuration of network components without specifying an exact native device configuration and control flow. By utilizing declarative requirements, what should be accomplished may be specified rather than how it should be accomplished. Declarative requirements may be contrasted with imperative instructions that describe the exact device configuration syntax and control flow to achieve the configuration. By utilizing declarative requirements rather than imperative instructions, a user and/or user system is relieved of the burden of determining the exact device configurations required to achieve a desired result of the user/system. For example, it is often difficult and burdensome to specify and manage exact imperative instructions to configure each device of a network when various different types of devices from different vendors are utilized. The types and kinds of devices of the network may dynamically change as new devices are added and device failures occur. Managing various different types of devices from different vendors with different configuration protocols, syntax, and software versions to configure a cohesive network of devices is often difficult to achieve. Thus, by only requiring a user/system to specify declarative requirements that specify a desired result applicable across various different types of devices, management and configuration of the network devices becomes more efficient. Further example details and techniques of an intent-based network management system are described in U.S. Pat. No. 10,756,983, entitled “Intent-based Analytics,” and U.S. Pat. No. 10,992,543, entitled “Automatically generating an intent-based network model of an existing computer network,” each of which is incorporated by reference herein in its entirety.

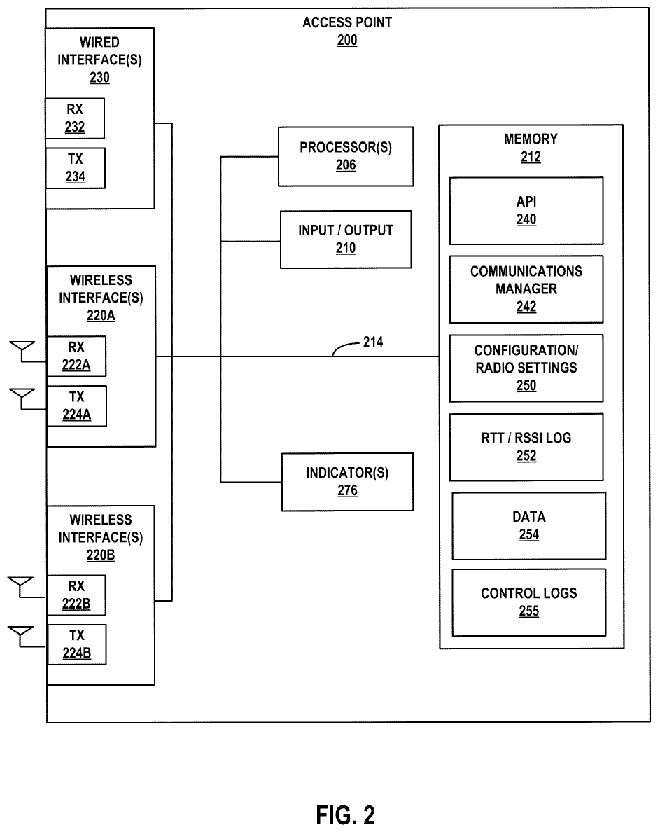

FIG. 2 is a block diagram of an example access point (AP) device 200 configured in accordance with one or more techniques of the disclosure. Example access point 200 shown in FIG. 2 may be used to implement any of AP devices 142 as shown and described herein with respect to FIG. 1A. Access point device 200 may comprise, for example, a Wi-Fi, Bluetooth and/or Bluetooth Low Energy (BLE) base station, or any other type of wireless access point.

In the example of FIG. 2, access point device 200 includes a wired interface 230, wireless interfaces 220A-220B, one or more processor(s) 206, memory 212, and user interface 210 (illustrated as “input/output 210”), and one or more indicators 276 coupled together via a bus 214 over which the various elements may exchange data and information. Wired interface 230 represents a physical network interface and includes a receiver 232 and a transmitter 234 for sending and receiving network communications, e.g., packets. Wired interface 230 couples, either directly or indirectly, access point device 200 to network(s) 134 of FIG. 1A. First and second wireless interfaces 220A and 220B represent wireless network interfaces and include receivers 222A and 222B, respectively, each including a receive antenna via which access point 200 may receive wireless signals from wireless communications devices, such as UEs 148 of FIG. 1A. First and second wireless interfaces 220A and 220B further include transmitters 224A and 224B, respectively, each including transmit antennas via which access point 200 may transmit wireless signals to wireless communications devices, such as UEs 148 of FIG. 1A. In some examples, first wireless interface 220A may include a Wi-Fi 802.11 interface (e.g., 2.4 GHz, 5 GHz, 6 GHz, or other wireless communication frequency) and second wireless interface 220B may include a Bluetooth interface and/or a Bluetooth Low Energy (BLE) interface. One or both of wireless interfaces(s) 220 may include an array of transmit and/or receive antennas. However, the above are given for example purposes only, and the disclosure is not limited in this respect.

Processor(s) 206 are programmable hardware-based processors configured to execute software instructions, such as those used to define a software or computer program, stored to a computer-readable storage medium (such as memory 212), such as non-transitory computer-readable media including a storage device (e.g., a disk drive, or an optical drive) or a memory (such as Flash memory or RAM), or any other type of volatile or non-volatile memory, that stores instructions to cause the one or more processors 206 to perform one or more of the techniques described herein.

Memory 212 includes one or more devices configured to store programming modules and/or data associated with operation of access point device 200. For example, memory 212 may include a computer-readable storage medium, such as non-transitory computer-readable media including a storage device (e.g., a disk drive, or an optical drive) or a memory (such as Flash memory or RAM) or any other type of volatile or non-volatile memory, that stores instructions to cause the one or more processor(s) 206 to perform one or more of the techniques described herein.

In this example, memory 212 stores executable software and various data including an application programming interface (API) 240, a communications manager 242, configuration settings 250, round-trip time (RTT)/RSSI log 252, data storage 254, and control log 255. RTT/RSSI log 252 includes RTT values and/or RSSI values measured by AP 200 with respect to one or more other APs in the wireless network. Although example RTT and RSSI techniques are described herein, it shall be understood that any method of estimating distances between two APs may be used, including any type of Wi-Fi ranging technique and/or Bluetooth ranging technique, and the disclosure is not limited in this respect.

The RTT and/or RSSI value(s) may be used to estimate a distance between two AP(s). For example, AP 200 may measure the RSSI values of received wireless signals transmitted by one or more other APs and store the measured value in RTT/RSSI log 252. The RSSI values may then be used by AP 200, NMS 130, or both, to estimate a distance between AP 200 and the one or more other APs in the wireless network. As another example, AP 200 and one or more other APs may perform round trip time (RTT) (e.g., time-of-flight (ToF)) measurements between each other and store the measured values in their respective RTT/RSSI log 252. RTT techniques may then be used by AP 200, NMS 130, or both, to estimate the distance between the two APs. Example Wi-Fi RTT techniques are described by the IEEE 802.11mc (i.e., IEEE 802.11-2016) standard, which defines a fine-time measurement (FTM) protocol that can be used to measure the Wi-Fi signal round trip time (RTT). In some examples, AP 200 sends the RTT/RSSI values to NMS 130, and NMS 130 estimates a distance between AP 200 and one or more other APs based on the received RTT/RSSI values received from each of the plurality of APs. In other examples, each AP 200 estimates the distance between itself and one or more other APs in the wireless network based on the RTT or RSSI values, and transmits the estimated distances to NMS 130. The estimated distances between APs may also be determined by any other computing device, and the disclosure is not limited in this respect. In accordance with one or more techniques of the disclosure, NMS 130 may obtain the RTT or RSSI values and generate a network graph of the APs, which in turn is used to automatically group the APs that is used learn the wireless network environment.

Network data stored in data storage 254 may include, for example, data concerning or associated with AP events and/or UE events. In some examples, the network events are classified as positive network events, neutral network events, and/or negative network events. The network events may include, for example, memory status, reboot events, crash events, Ethernet port status, upgrade failure events, firmware upgrade events, configuration changes, authentication events, DNS events, DHCP events, one or more types of roaming events, one or more types of proximity events, etc., as well as a time and date stamp for each event. Control logs 255 determines a logging level for the device based on instructions from NMS 130. Data 254 may store any data used and/or generated by access point device 200, including data collected from UEs 148.

Communications manager 242 includes program code that, when executed by processor(s) 206, allow access point 200 to communicate with UEs 148 and/or network(s) 134 via any of interface(s) 230 and/or 220A-220B. Configuration settings 250 include any device settings for access point 200 such as radio settings for each of wireless interface(s) 220A-220B. These settings may be configured manually or may be remotely monitored and/or automatically managed or configured by NMS 130 to optimize wireless network performance on a periodic (e.g., hourly or daily) basis.

Input/output (I/O) 210 represents physical hardware components that enable interaction with a user, such as buttons, a touchscreen, a display, and the like. Although not shown, memory 212 typically stores executable software for controlling a user interface with respect to input received via I/O 210.

Indicator(s) 276 include, for example, one or more multi-color LEDs used to visibly communicate a status of the AP. For example, AP 200 is configured to control indicator(s) 276 to blink out codes comprised of one or more colors or patterns to indicate the status of the AP 200. The codes may include one or more normal status codes (e.g., AP powering up, AP booting, AP connecting to cloud, at least one wireless client connected to AP, AP upgrading, AP locate mode, etc.) and/or one or more error status codes (e.g., insufficient power, no Ethernet link, one or more DHCP errors, one or more DNS errors, one or more cloud unreachable errors, one or more tunneling protocol errors, one or more boot configuration errors, one or more firmware errors, etc.).

Indicator(s) 276 are positioned on one side (e.g., a top surface) of the AP and provide visual confirmation to the installer of the proper orientation of the AP during the installation process. For example, when the AP is deployed in a typical ceiling mounted configuration, indicator 276 should be visible to the installer and thus face generally downwards toward the floor rather than toward the ceiling. Likewise, when the AP is deployed in a floor mounted configuration, indicator 276 should face generally upwards toward the ceiling, whereas in a wall mounted configuration the indicator will face generally to the side. Indicator(s) 276 therefore increase consistency of installation by helping to ensure that all APs installed on the ceiling are installed in the same orientation with the indicator facing down and that all APs installed on the floor are installed with the indicator facing up. Indicator(s) 276 are thus one mechanism by which the system can rely on an assumption that APs installed on the ceiling are correctly oriented with the indicator facing down and the APs installed on the floor are oriented with the indicator facing up. Indicators 276 are also useful for purposes of troubleshooting deployed AP(s) and/or for purposes of locating a specific AP.

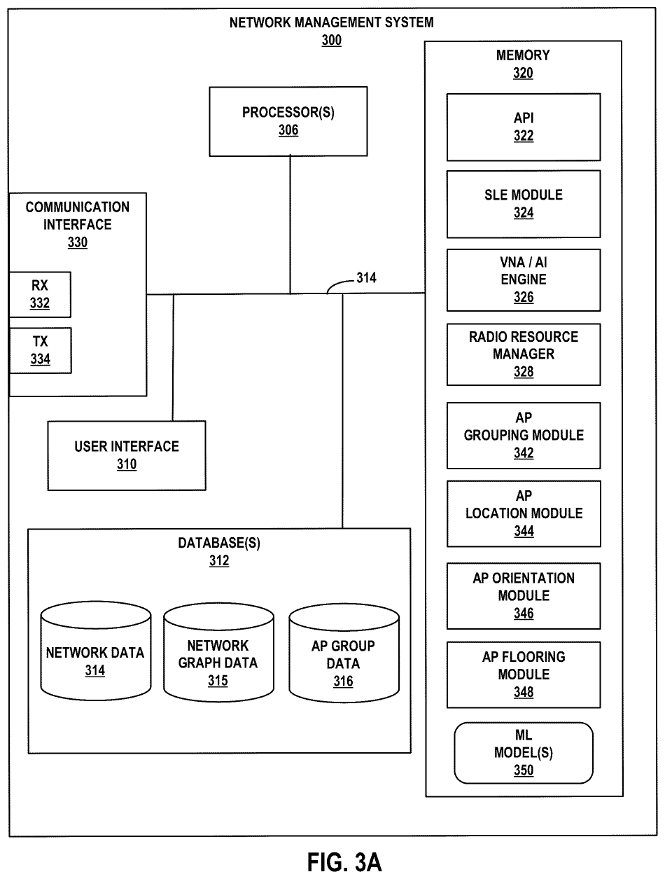

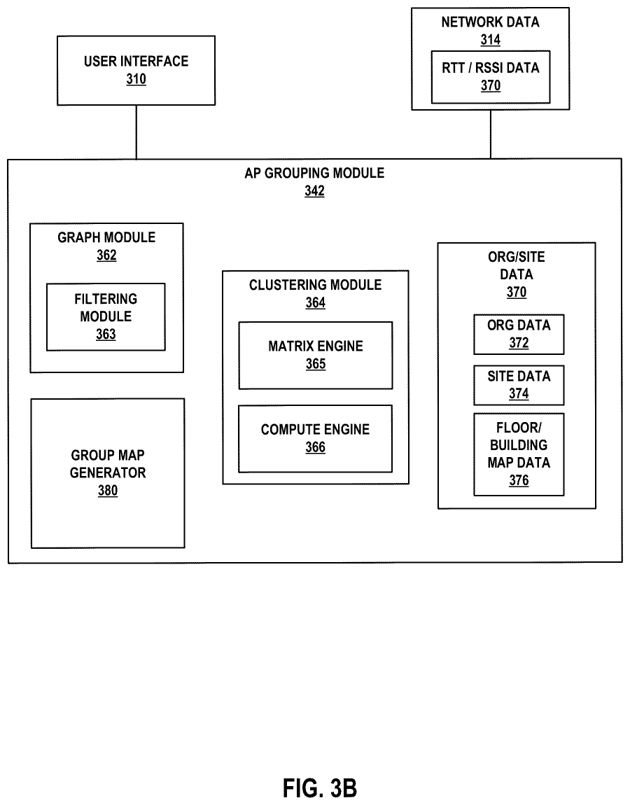

FIG. 3A is a block diagram of an example network management system (NMS) 300 configured to automatically group one or more deployed APs in a wireless network that is used to learn the wireless network environment, in accordance with one or more techniques of the disclosure. NMS 300 may be an example implementation of NMS 130 in FIGS. 1A-1B. In such examples, NMS 300 is responsible for monitoring and management of one or more wireless networks 106A-106N at sites 102A-102N, respectively, including automatically grouping APs that is used to learn the wireless network environment. In some examples, NMS 300 receives network data collected by AP devices 142, such as network data including information about detected radio signals (e.g., RSSI values) used to determine connection relationships between deployed APs, and analyzes this data for cloud-based management of wireless networks 106A-106N. In some examples, NMS 300 may be part of another server shown in FIG. 1A or a part of any other server or computing device.

NMS 300 includes a communications interface 330, one or more processor(s) 306, a user interface 310, a memory 320, and a database 312. The various elements are coupled together via a bus 314 over which the various elements may exchange data and information.

Processor(s) 306 execute software instructions, such as those used to define a software or computer program, stored to a computer-readable storage medium (such as memory 320), such as non-transitory computer-readable media including a storage device (e.g., a disk drive, or an optical drive) or a memory (such as Flash memory or RAM), or any other type of volatile or non-volatile memory, that stores instructions to cause the one or more processors 306 to perform the techniques described herein.

Communications interface 330 may include, for example, an Ethernet interface. Communications interface 330 couples NMS 300 to a network and/or the Internet, such as any of network(s) 134 as shown in FIG. 1A, and/or any local area networks. Communications interface 330 includes a receiver 332 and a transmitter 334 by which NMS 300 receives/transmits data and information to/from any of AP devices 142, admin device 111, servers 110, 116, 122, 128, and/or any other devices or systems forming part of network 100, such as shown in FIGS. 1A-1B. The data and information received by NMS 300 may include, for example, network data and/or event log data received from access points 142 used by NMS 300 to remotely monitor and/or control the performance of wireless networks 106A-106N, and to automatically group APs 142 used to learn the wireless network environment of sites 102. NMS 300 may further transmit data via communications interface 330 to any of network devices such as APs 142 at any of network sites 102A-102N to remotely manage wireless networks 106A-106N.

Memory 320 includes one or more devices configured to store programming modules and/or data associated with operation of NMS 300. For example, memory 320 may include a computer-readable storage medium, such as non-transitory computer-readable media including a storage device (e.g., a disk drive, or an optical drive) or a memory (such as Flash memory or RAM), or any other type of volatile or non-volatile memory, that stores instructions to cause the one or more processor(s) 306 to perform the techniques described herein.

In this example, memory 320 includes API 322, SLE module 324, a virtual network assistant (VNA)/AI engine 326, a radio resource management (RRM) engine 328, AP grouping module 342, AP location module 344, AP orientation module 346, AP flooring module 348, and one or more machine learning models 350. NMS 300 may also include any other programmed modules, software engines, and/or interfaces configured for remote monitoring and management of wireless networks 106A-106N, including remote monitoring and management of any of AP devices 142.

RRM engine 328 monitors one or more metrics for each site 102A-102N in order to learn and optimize the power and/or radio-frequency (RF) environment at each site. For example, RRM engine 328 may monitor the coverage and capacity SLE metrics (e.g., managed by SLE module 324) for a wireless network 106 at a site 102 in order to identify potential issues with coverage and/or capacity in the wireless network 106 and to adjust the radio settings of the access points at each site to address the identified issues. RRM engine 328 may determine channel and transmit power distribution across all AP devices 142 in each network 106A-106N. RRM engine 326 may monitor events, power, channel, bandwidth, and number of clients and/or APs connected to each AP device. RRM engine 328 may measure the strength of a radio signal of client devices and APs and/or between APs, such as an RSSI value. The RSSI values for each of the plurality of APs may be stored in a database or other storage media, such as network data 314, for further monitoring and/or analysis. RRM engine 328 may further automatically change or update configurations of one or more AP devices 142 at a site 102 with an aim to improve the coverage and/or capacity SLE metrics and thus to provide an improved wireless experience for the user. In some examples, RRM engine 328 may use information determined by AP grouping module 342, AP location module 344, AP orientation engine 346, and/or AP floor engine 348, in order to learn and optimize the wireless network environment provided by the wireless network.

VNA/AI engine 326 analyzes network data received from AP devices 142 as well as its own data to monitor performance of wireless networks 106A-106N. For example, VNA engine 326 may identify when anomalous or abnormal states are encountered in one of wireless networks 106A-106N. VNA/AI engine 326 may use a root cause analysis module (not shown) to identify the root cause of any anomalous or abnormal states. In some examples, the root cause analysis module utilizes artificial intelligence-based techniques to help identify the root cause of any poor SLE metric(s) at one or more of wireless networks 106A-106N. In addition, VNA/AI engine 326 may automatically invoke one or more remedial actions intended to address the identified root cause(s) of one or more poor SLE metrics. Examples of remedial actions that may be automatically invoked by VNA/AI engine 326 may include, but are not limited to, invoking RRM 328 to reboot one or more AP devices and/or adjust/modify the transmit power of a specific radio in a specific AP device, adding service set identifier (SSID) configuration to a specific AP device, changing channels on an AP device or a set of AP devices, etc. The remedial actions may further include restarting a switch and/or a router, invoke downloading of new software to an AP device, switch, or router, etc. These remedial actions are given for example purposes only, and the disclosure is not limited in this respect. If automatic remedial actions are not available or do not adequately resolve the root cause, VNA/AI engine 326 may proactively and automatically provide a notification including recommended remedial actions to be taken by IT personnel to address the anomalous or abnormal wireless network operation.

SLE module 324 enables set up and tracking of thresholds for one or more SLE metrics for each of wireless networks 106A-106N. SLE module 324 further analyzes network data (e.g., stored as network data 314) collected by AP devices and/or UEs associated with wireless networks 106A-106N, such as any of AP devices 142 from UEs 148 in each wireless network 106A-106N. For example, AP devices 142A-1 through 142A-N collect network data from UEs 148A-1 through 148A-N currently associated with wireless network 106A (e.g., named assets, connected/unconnected Wi-Fi clients). This data, in addition to any network data collected by one or more APs 142A-1 through 142A-N in wireless network 106A, is transmitted to NMS 300 and stored as, for example, network data 314.

NMS 300 executes SLE module 324 to determine one or more SLE metrics for each UE 148 associated with a wireless network 106. One or more of the SLE metrics may further be aggregated to each AP device at a site to gain insight into contribution of each AP device to wireless network performance at the site. The SLE metrics track whether the service level for each particular SLE metric meets the configured threshold value(s). In some examples, each SLE metric may further include one or more classifiers. If a metric does not meet the configured SLE threshold value for the site, the failure may be attributed to one of the classifiers to further understand how and/or why the failure occurred.

AP location module 344, when executed by one or more processor(s) of NMS 300, causes NMS 300 to automatically determine the x, y (and in some examples, z) coordinate locations of each AP of each group of APs at a site in a global coordinate system for the site. For purposes of the examples given in the present disclosure, the global coordinate system is a Cartesian coordinate system in which the x, y plane is defined by a horizontal plane substantially parallel to the floors and ceiling of a multi-floor building. The z-axis of the global coordinate system is defined as being perpendicular to the x-y plane. The origin of the global coordinate system is a defined fixed location at the site of the multi-floor structure. However, the global coordinate system may be defined in any other way, and the disclosure is not limited in this respect. For example, the global coordinate system may include a Cartesian coordinate system in which the x, y, and z-axes are defined in a different way with respect to the site. In other examples, the global coordinate system may include a spherical coordinate system, a latitude-longitude based coordinate system, or any other system in which the positions of one or more APs at a site may be uniquely identified.

Example techniques for automatic determination of x, y and/or z coordinates and/or location of one or more APs in a wireless network are described in U.S. patent application Ser. No. 17/811,784, filed Jul. 11, 2022, and entitled, “Determining Locations of Deployed Access Points,” U.S. Pat. No. 11,422,224, issued Aug. 23, 2022, and entitled “Location Determination Based on Phase Differences,” and U.S. Pat. No. 11,696,092, issued Jul. 4, 2023, and entitled “Multi-Wireless Device Location Determination,” each of which is incorporated by reference herein in its entirety. However, other techniques may also be used, and the disclosure is not limited in this respect. In addition, or alternatively, the x, y and/or z coordinates of each AP may be manually entered for storage by the NMS 300 or in an associated database at the time of installation, as a result of a site survey, or at any other time.

In some examples, AP location module 344 may use the automatically grouped APs, as described in this disclosure, to automatically determine the floor locations of deployed APs, such as determining a floor number of an AP group and/or an order of the floors of groups of APs. Example techniques for automatically determining floor locations of deployed APs are described in U.S. patent application Ser. No. 18/305,040, filed Apr. 21, 2023, and entitled “Systems and Methods of Determining Floor Locations of Deployed Access Points,” the entire contents of which is incorporated by reference herein.

AP orientation module 344, when executed by one or more processor(s) of NMS 300, causes NMS 300 to automatically determine the orientation of deployed APs of each group of APs in the global coordinate system for the site. For purposes of the present disclosure, the orientation angle of an AP is referred to as an angle, β, at which at fixed point on the AP is rotated with respect to the y-axis of the global coordinate system for the site. Example techniques for automatic determination of the orientation of one or more APs in a wireless network is described in U.S. patent application Ser. No. 17/651,526, filed Feb. 17, 2022, and entitled, “Determining Orientation of Deployed Access Points,” which is incorporated by reference herein in its entirety. However, other techniques may also be used, and the disclosure is not limited in this respect. In addition, or alternatively, the orientation of each AP may be manually entered for storage by the NMS 300 or in an associated database at the time of installation, as a result of a site survey, or at any other time.

In accordance with one or more techniques of the disclosure, NMS 300 includes an AP grouping module 342 which, when executed by one or more processors of NMS 300, causes NMS 300 to automatically group one or more deployed APs that is used to learn the wireless network environment.

For example, AP grouping module 342 is configured to generate, based on RSSI values of the plurality of APs managed by NMS 300, a network graph for a plurality of deployed APs that represent the neighbor relationship between APs, and generate a matrix representation (e.g., Laplacian matrix) of the network graph that is used to form groups of APs. NMS 300 may store the network graph data (e.g., information from the network graph and/or matrix) for each of the plurality of APs in a database or other storage media, such as network graph data 315, for further monitoring and/or analysis, such as by applying a clustering algorithm to the network graph data 315 to form groups of the plurality of APs, as further described below.

Each group formed by the application of the clustering algorithm includes one or more APs installed on the same floor of a multi-floor structure of a site or in the same building of a multi-building site. Each group of APs includes a unique identifier indicative of the group of APs with respect to the site, such as a specific floor number of a plurality of floor numbers of the multi-floor structure of a site (or the building number of a multi-building site) on which the group of APs is installed. NMS 300 may store the group information (e.g., unique identifier assigned to group of APs) for each of the groups of APs in a database or other storage media, such as AP group data 316, for further monitoring and/or analysis, such as determining the locations of the deployed APs.

In some examples, NMS 300 automatically generates one or more notifications and/or automatically invokes one or more actions based on the location(s), orientation(s), and/or group information for one or more of the plurality of APs or groups of APs. In some examples, NMS 300 uses the location(s), orientation(s), and/or group information stored or determined for one or more of the plurality of APs or groups of APs to provide location services for one or more client devices associated with the wireless network(s) at the site. Additional details of AP grouping module 342 are described below in FIG. 3B.

FIG. 3B is a block diagram of an example AP grouping module 342 configured to automatically group one or more deployed APs that is used to learn the wireless network environment, in accordance with one or more techniques of the disclosure.

In general, each AP deployed within a site (e.g., APs 142 of site 102A of FIG. 1A) includes one or more wireless transmitter(s) by which the AP transmits wireless signals and one or more receiver(s) that receives wireless signals from one or more other APs 142 and/or wireless client devices associated with a wireless network. In some examples, the receiving AP uses the power of the received wireless signals to determine the received signal strength (RSSI) associated with the wireless signals received by the AP and originating from (e.g., transmitted by) one or more other APs in the wireless network. Each AP may also be configured to measure a time of flight (ToF)-based round trip time (RTT) between the AP and one or more other APs. The AP may store the RTT and/or RSSI values in, for example, RTT/RSSI log 252 of FIG. 2. The RTT and/or RSSI values may be used to estimate a distance between the two APs. The RSSI and/or RTT values and/or the corresponding estimated distances may also be transmitted from the APs to NMS 130/300 where it may be stored in network data 314 of FIG. 3A. When executed by one or more processors of NMS 300, AP grouping module 342 may obtain the RSSI and/or RTT values and/or the corresponding estimated distances (e.g., RTT/RSSI data 370 of FIG. 3B), via a bus 314, and use the RTT/RSSI data 370 to automatically group the one or more deployed APs in the wireless network for determining the locations of the deployed APs.

In the example of FIG. 3B, AP grouping module 342 of NMS 300 may include one or more software modules and/or engines that, when executed by the one or more processors (e.g., processor(s) 306 of FIG. 3A), cause the processors to automatically group one or more deployed APs. For example, AP grouping module 342 may include a graph module 362 and a clustering module 364. Graph module 362 may obtain RTT/RSSI data 370 and based on the RTT/RSSI data 370, graph module 362 generates a network graph of the plurality of APs that represents neighbor relationships between the plurality of APs. Graph module 362 may generate the network graph based on one or more graphical models, such as an undirected graphical model, or any other type of graphical model.

In some examples, graph module 362 may include a filtering module 363 to filter the network graph such that the network graph uses a smaller data set of APs. For example, filtering module 363 may apply, for example, an RSSI threshold to filter the network graph of APs to reduce the data set of APs that have, for example, the strongest connectivity. For instance, an administrator may specify the RSSI threshold (e.g., −70 dBm), via user interface 310, which the filtering module 363 may use to filter out connections between APs that have less than −70 dBm.

Clustering module 364 is configured to automatically group one or more APs based on the neighbor relationships between the plurality of APs in the network graph. In this example, clustering module 364 includes a matrix engine 365 that is configured to generate a matrix representation of the network graph of the APs, such as a Laplacian matrix. For example, matrix engine 365 may generate a degree matrix (D) that is a diagonal matrix specifying information of the degree of each node (e.g., number of edges incident to the node, which represents the number of connections of an AP to other APs). Matrix engine 365 may also generate an adjacency matrix (A) that specifies information of the adjacency of the nodes in the network graph (e.g., information identifying which APs have connectivity). To generate a Laplacian matrix representing the network graph of APs, matrix engine 365 computes the difference of the degree matrix and the adjacency matrix.

In response to generating the Laplacian matrix that represents the network graph of APs, compute engine 366 of clustering module 364 may compute eigenvalues and eigenvectors based on the Laplacian matrix. An eigenvector is a vector that changes based on a scalar factor when a linear transformation is applied to the vector. The scalar factor by which an eigenvector is scaled is referred to as eigenvalue.

Compute engine 366 may apply a clustering algorithm on the eigenvalues and eigenvectors, such as a k-means clustering algorithm, or any other spectral clustering algorithm. For example, the administrator may specify, via user interface 310, the value of “k” that may represent the number of floors of a multi-floor structure of a site or the number of buildings of a multi-building site, and compute engine 366 may compute a number of eigenvectors based on the value of k. Compute engine 366 may apply the clustering algorithm on the eigenvalues computed from the Laplacian matrix to determine how the nodes in the network graph are connected to each other. For example, the clustering algorithm may determine the number of eigenvalues of zero (0), which correspond to the number of connected components (e.g., densely populated areas of APs) in the network graph. For instance, if the number of eigenvalues of zero is one, then the clustering algorithm may determine that there is at least one connected component (e.g., connection between two densely populated areas of APs). Compute engine 366 may apply the clustering algorithm on the eigenvalues computed from the Laplacian matrix to determine the connection density of the network graph (e.g., the higher the spectral gap, the greater the density of the connection between nodes). For example, the clustering algorithm may determine the first non-zero eigenvalue (e.g., smallest non-zero eigenvalue) is referred to as a “spectral gap” or “eigen gap,” which corresponds to the connection density of the network graph (e.g., the higher the spectral gap, the greater the density of the connection between nodes). For instance, if the spectral gap is near zero, the clustering algorithm may determine that there is an edge on the network graph that is not densely connected to other APs, and thus a graph cut can be made to separate the graph into separate groups. The clustering algorithm may also determine the second-smallest eigenvalue, referred to as a “Fiedler value,” which may represent a minimum graph cut needed to separate the graph into two connected components (e.g., two densely populated areas of APs). The clustering algorithm may further determine a corresponding vector to the Fiedler value, referred to as a “Fiedler vector,” to create labels for the groups of APs.

Compute engine 366 may apply the clustering algorithm to the eigenvectors computed from the Laplacian matrix to assign the data into clusters. For example, a row in an eigenvectors matrix computed from the Laplacian matrix may represent, for example, connection properties of a particular AP (e.g., node of the network graph). Compute engine 366 may apply the clustering algorithm to the eigenvalues to determine the Fiedler value, which in turn is used to determine the corresponding Fiedler vector within the eigenvectors which is used to determine which side of the graph cut a node belongs, and to uniquely assign, based on the k-means clustering algorithm, an identifier indicative of a group of APs with respect to the site. The identifier may include a number (e.g., floor number, building number, etc.), a color, a label, or any other identifier indicative of a group of APs with respect to the site. In some examples, each group of APs is assigned with any indicator, such as a numerical value, a color, non-numerical text, or any other type of indicator. In some examples, the group information is stored in AP group data 316 of FIG. 3A.

In some examples, an administrator may use user interface 310 to specify organization and/or site information (e.g., illustrated as org/site data 370) that is used to group the APs. For example, organization data 372 may include, for example, a name or other identifying information of an organization for which NMS 300 provides wireless network services. Organization data 372 may also include any other organization-specific information. Site data 374 may include information associated with each site of an organization, such as a name or other identifying information for each site and may also include any other site-specific information. Site data 374 for each of the sites is further associated with each of a plurality of floor/building map data 376, where the floor/building map data 376 includes information identifying a number of floors (or buildings) of each site, one or more anchor APs for each floor (or building), or any other identifying information for each floor (or building) of a site.

As one example, the administrator may use user interface 310 to specify a predetermined floor number and one or more anchor APs for each floor of the plurality of floors at the time of installation (or at some other appropriate time). In this example, clustering module 364 may determine a particular floor may include a plurality of densely populated areas of APs (e.g., two sub-groups of APs on the particular floor). In this example, the one or more anchor APs are used to determine whether the plurality of densely populated areas of APs are on the same floor and can group the sub-groups of APs into a single group of APs for the same floor.

In some examples, NMS 130/300 may use the group information to determine the location of APs of each group of APs. For example, as described above, AP location module 344 of NMS 300 may automatically determine the x, y (and in some examples, z) coordinate locations of each AP of each group of APs at a site in a global coordinate system for the site, such as described in U.S. patent application Ser. No. 17/811,784, U.S. Pat. Nos. 11,422,224, and 11,696,092, each of which is incorporated by reference above in its entirety.

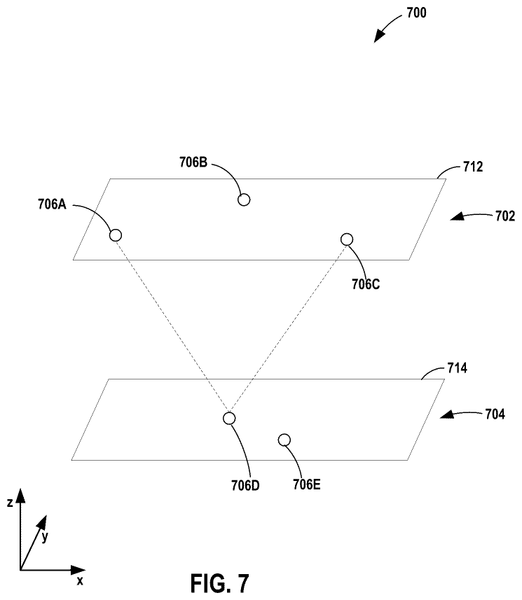

In some examples, AP grouping module 342 includes group map generator 380 configured to generate a site map (e.g., floor map or building map of the site) based on the automatic grouping of the one or more deployed APs. As further described below in FIG. 7, group map generator 380 may generate a site map that includes a visualization of the groups of APs deployed within the site. As one example, group map generator 380 may generate a visualization of groups of APs on assigned floors of a multi-floor building or other structure.

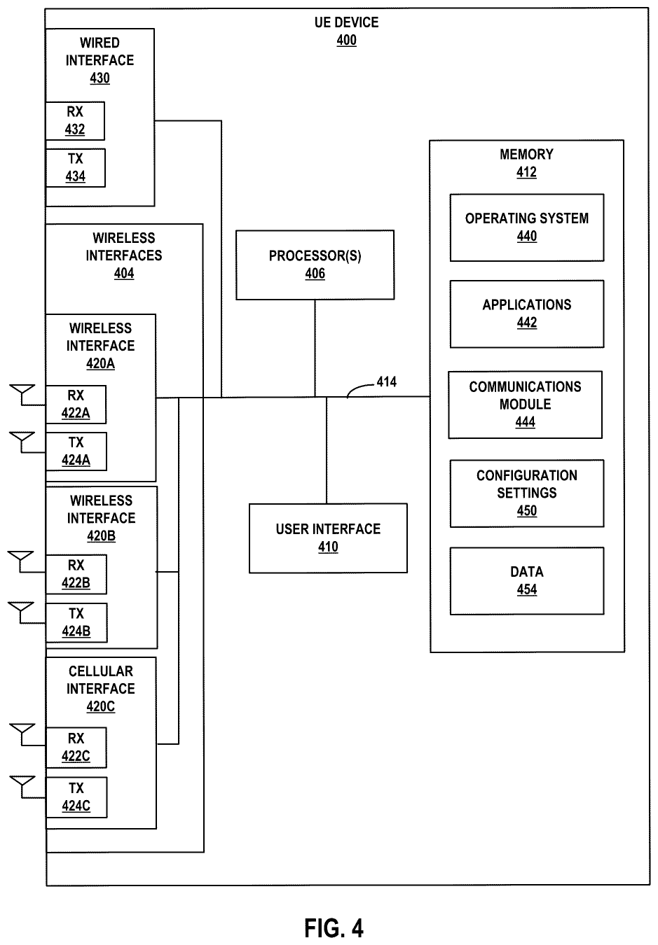

FIG. 4 shows an example user equipment (UE) device 400. Example UE device 400 shown in FIG. 4 may be used to implement any of UEs 148 as shown and described herein with respect to FIG. 1A. UE device 400 may include any type of wireless client device, and the disclosure is not limited in this respect. For example, UE device 400 may include a mobile device such as a smart phone, tablet or laptop computer, a personal digital assistant (PDA), a wireless terminal, a smart watch, a smart ring or any other type of mobile or wearable device. UE 400 may also include any type of IoT client device such as a printer, a security sensor or device, an environmental sensor, or any other connected device configured to communicate over one or more wireless networks.

In accordance with one or more techniques of the disclosure, NMS 130/300 receives relevant network data from UEs 148 on a continuous basis (e.g., every 2 seconds or other appropriate time period). The network data 454 may include, for example, RSSI measurements of one or more wireless signals received from one or more AP devices by UE 400 as measured by the AP devices, as well as any other network information obtained or measured by the UEs.

UE device 400 includes a wired interface 430, wireless interfaces 420A-420C, one or more processor(s) 406, memory 412, and a user interface 410. The various elements are coupled together via a bus 414 over which the various elements may exchange data and information. Wired interface 430 includes a receiver 432 and a transmitter 434. Wired interface 430 may be used, if desired, to couple UE 400 to network(s) 134 of FIG. 1. First, second and third wireless interfaces 420A, 420B, and 420C include receivers 422A, 422B, and 422C, respectively, each including a receive antenna via which UE 400 may receive wireless signals from wireless communications devices, such as AP devices 142 of FIG. 1, AP device 200 of FIG. 2, other UEs 148, or other devices configured for wireless communication. First, second, and third wireless interfaces 420A, 420B, and 420C further include transmitters 424A, 424B, and 424C, respectively, each including transmit antennas via which UE 400 may transmit wireless signals to wireless communications devices, such as AP devices 142 of FIG. 1A, AP device 200 of FIG. 2, other UEs 148 and/or other devices configured for wireless communication. In some examples, first wireless interface 420A may include a Wi-Fi 802.11 interface (e.g., 2.4 GHz and/or 5 GHz) and second wireless interface 420B may include a Bluetooth interface and/or a Bluetooth Low Energy interface. Third wireless interface 420C may include, for example, a cellular interface through which UE device 400 may connect to a cellular network.

Processor(s) 406 execute software instructions, such as those used to define a software or computer program, stored to a computer-readable storage medium (such as memory 412), such as non-transitory computer-readable media including a storage device (e.g., a disk drive, or an optical drive) or a memory (such as Flash memory or RAM), or any other type of volatile or non-volatile memory, that stores instructions to cause the one or more processors 406 to perform the techniques described herein.

Memory 412 includes one or more devices configured to store programming modules and/or data associated with operation of UE 400. For example, memory 412 may include a computer-readable storage medium, such as non-transitory computer-readable media including a storage device (e.g., a disk drive, or an optical drive) or a memory (such as Flash memory or RAM), or any other type of volatile or non-volatile memory, that stores instructions to cause the one or more processor(s) 406 to perform one or more of the techniques described herein.

In this example, memory 412 includes an operating system 440, applications 442, a communications module 444, configuration settings 450, and data storage for network data 454. Data storage for network data 454 may include, for example, a status/error log including network data specific to UE 400. As described above, network data 454 may include any network data, events, and/or states that may be related to determination of one or more roaming quality assessments. The network data may include event data such as a log of normal events and error events according to a logging level based on instructions from the network management system (e.g., NMS 150/300). Data storage 454 may store any data used and/or generated by UE 400, such as network data used to determine proximity to a proximity zone, that is collected by UE 400 and transmitted to any of AP devices 142 in a wireless network 106 for further transmission to NMS 150. In one example implementation, the data may include a value of a measured RSSI of signals from various APs and/or measurements of RTT for signal traveled between the UE and one or more APs.

Communications module 444 includes program code that, when executed by processor(s) 406, enables UE 400 to communicate using any of wired interface(s) 430, wireless interfaces 420A-420B and/or cellular interface 450C. Configuration settings 450 include any device settings for UE 400 settings for each of wireless interface(s) 420A-420B and/or cellular interface 420C.

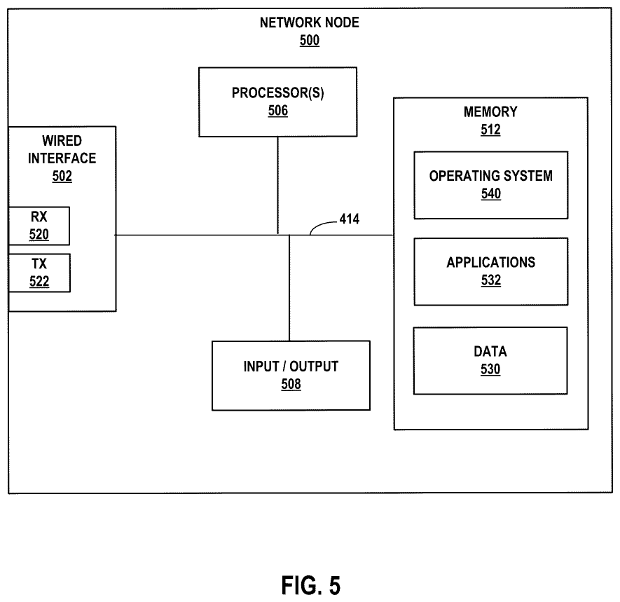

FIG. 5 is a block diagram illustrating an example network node 500 configured according to the techniques described herein. In one or more examples, the network node 500 implements a device or a server attached to the network 134 of FIG. 1, e.g., router, switch, AAA server 110, DHCP server 116, DNS server 122, VNA 133, AP location module 135, Web server 128A-128X, etc., or a network device such as, e.g., routers, switches or the like.

In this example, network node 500 includes a communications interface 502, e.g., an Ethernet interface, a processor 506, input/output 508, e.g., display, buttons, keyboard, keypad, touch screen, mouse, etc., a memory 512 and an assembly of components 516, e.g., assembly of hardware module, e.g., assembly of circuits, coupled together via a bus 509 over which the various elements may interchange data and information. Communications interface 502 couples the network node 500 to a network, such as an enterprise network.

Though only one interface is shown by way of example, those skilled in the art should recognize that network nodes may have multiple communication interfaces. Communications interface 502 includes a receiver 520 via which the network node 500 can receive data and information (e.g., including data indicative of distances between APs, and/or operation related information such as registration request, AAA services, DHCP requests, Simple Notification Service (SNS) look-ups, and Web page requests). Communications interface 502 includes a transmitter 522, via which the network node 500 can send data and information (e.g., including location information, configuration information, authentication information, web page data, etc.).

Memory 512 stores executable software applications 532, operating system 540 and data/information 530. Data 530 includes system log and/or error log that stores network data and/or proximity information for node 500 and/or other devices, such as wireless access points, based on a logging level according to instructions from the network management system. Network node 500 may, in some examples, forward the network data to a network management system (e.g., NMS 130/300 of FIG. 1A, 1B or 3A) for analysis as described herein. Network node 500 may in some examples perform one or more of the techniques for automatically grouping one or more APs as described herein.

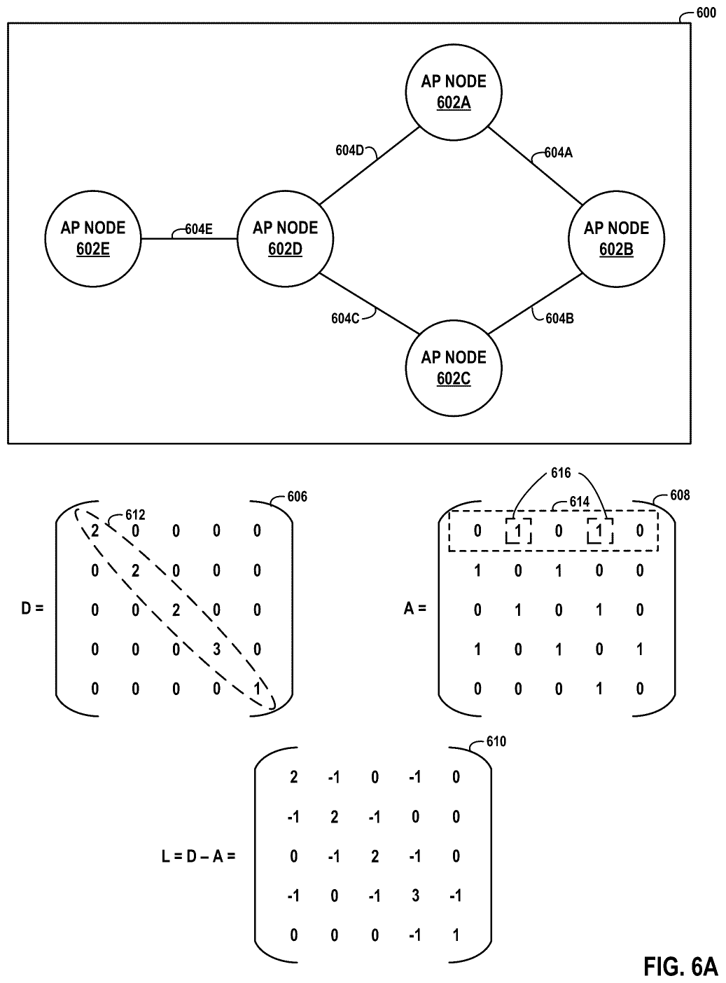

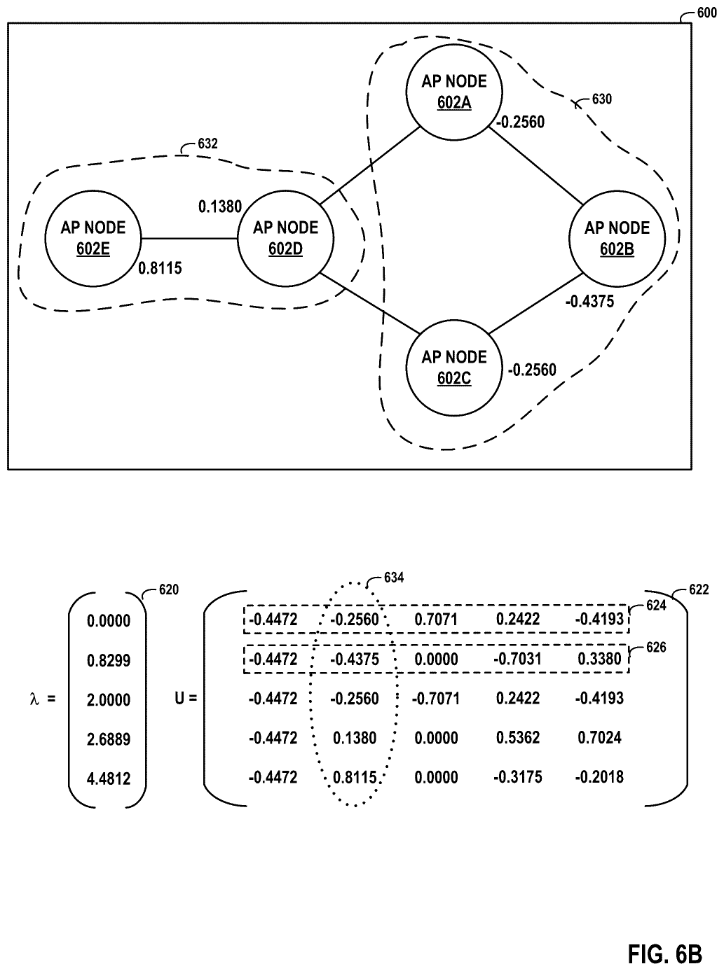

FIGS. 6A-6B show a conceptual diagram illustrating an example grouping of one or more deployed APs that is used to learn the wireless network environment, in accordance with one or more techniques of the disclosure. FIGS. 6A-6B are described with respect to NMS 300 of FIG. 3A and NMS AP grouping module 362 of FIG. 3B.

In the example of FIG. 6A, graph module 362 may obtain RTT/RSSI data 370 that specifies RTT/RSSI data of APs (e.g., APs 142A of site 102A), and based on the RTT/RSSI data 370, graph module 362 generates network graph 600 of the plurality of APs that represents neighbor relationships between the plurality of APs. AP nodes 602A-602E (collectively, “AP nodes 602”) of the network graph 600 may represent the deployed APs 142A at site 102A and each connection between AP nodes 602 in the graph, e.g., node connections 604A-604E (collectively, “node connections 604”) may represent the APs that can detect a radio signal from other APs. In this example, AP node 602A may represent an AP that detects radio signals of a certain signal strength from two other APs represented by AP node 602B and AP node 602D and is represented by a node connection 604A that connects AP node 602A and AP node 602B, and node connection 604D that connects AP node 602A and AP node 602D. Similarly, AP node 602B may represent an AP that detects radio signals of a certain signal strength from two other APs represented by AP node 602A and AP node 602C and is represented by a node connection 604A that connects AP 602B and AP node 602A, and node connection 604B that connects AP node 602B and AP node 602C, and so on.

Based on network graph 600, matrix engine 365 of clustering module 364 may generate a degree matrix (D) 606 that is a diagonal matrix specifying information of the degree of each of AP nodes 602 (illustrated in FIG. 6A as element 612). In this example, AP node 602A, AP node 602B, and AP node 602C each has two edges incident to the node. Similarly, AP node 602D has three edges incident to AP node 602D, and AP node 602E has a single edge incident to AP node 602E.

Matrix engine 365 may also generate an adjacency matrix (A) 608 that specifies information of the adjacency of AP nodes 602 in network graph 600. In this example, each row and column may represent the adjacencies of a particular AP node and comprise values indicative of an adjacency of the particular AP node to another AP node. For instance, in adjacency matrix 608, row 614 may comprise values indicative of an adjacency of AP node 602A to other AP nodes. The row immediately below row 614 may comprise values indicative of an adjacency of AP node 602B to other AP nodes, and so on. Similarly, the left-most column in adjacency matrix 614 may comprise values indicative of the adjacency of AP node 602A to other AP nodes, the column immediately to the right of the left-most column may comprise values indicative of the adjacency of AP node 602B to other AP nodes, and so on. In this example, AP node 602A is adjacent to AP node 602B and AP node 602D, respectively, and is represented by a value of one in each of the columns corresponding to AP node 602B and AP node 602D (e.g., as illustrated in FIG. 6A by elements 616). In this example, a value of one in row 614 may be indicative of communication (e.g., a detected radio signal or a detected radio signal that satisfies an RSSI threshold) between AP node 602A and AP node 602B, and between AP node 602A and AP node 602D. A value of zero in row 614 may be indicative of no communication (or a detected radio signal that does not satisfy an RSSI threshold) between AP node 602A and AP node 602C, and between AP node 602A and AP node 602E. Similarly, AP node 602B is adjacent to AP node 602A and AP node 602C, respectively, and is represented by a value of one in each of the columns corresponding to AP node 602A and AP node 602C as shown in the row immediately below row 614, and so on. In this example, adjacency matrix 608 includes a value of ones and zeroes to indicate the detected connectivity of AP nodes, but may include, in other examples, other values, such as weighted values indicative of a strength of the signals, a direction of the signals, or other additional information about the signals. For example, adjacency matrix 608 may alternatively include values (or normalized values) indicative of the signal strength of detected signals (e.g., RSSI values of radio signals). In these examples, the use of weighted values in the adjacency matrix may be indicative of an amount of the adjacency of AP nodes. As one example, RSSI values indicative of a stronger signal strength in the adjacency matrix may be indicative of adjacent AP nodes that are closer in adjacency (e.g., strong neighbors) and RSSI values indicative of weaker signal strength in the adjacency matrix may be indicative of AP nodes that are further in adjacency (e.g., AP nodes that are not neighbors and/or AP nodes that are on different floors).

Matrix engine 365 may generate a Laplacian matrix 610 representing network graph 600 by computing the difference of the degree matrix 606 and the adjacency matrix 608. As further described in FIG. 6B, clustering module 364 may automatically group the one or more deployed APs based on the Laplacian matrix 610 representing network graph 600.

In the example of FIG. 6B, matrix engine 365 may compute eigenvalues, represented by eigenvalues matrix 620, and eigenvectors, represented by eigenvectors matrix 622, based on Laplacian matrix 610 of FIG. 6A. In this example, eigenvectors matrix 622 includes rows that each represent, for example, connection properties of a particular AP (e.g., node of the network graph). For instance, row 624 in eigenvectors matrix 622 may represent the connection properties of AP node 602A, row 626 in eigenvectors matrix 622 may represent the connection properties of AP node 602B, and so on. The number of computed eigenvectors may be based on, for example, the number of desired clusters that represents the number of floors of the multi-floor structure (or number of buildings or sections of a multi-building site). In this example, eigenvectors matrix 622 includes five computed eigenvectors for AP nodes 602A-602E (represented by each column of eigenvectors matrix 622), which may represent the five floors of the multi-floor structure. Compute engine 366 of clustering module 364 may apply a clustering algorithm on the eigenvalues and eigenvectors, such as a k-means clustering algorithm or any other spectral clustering algorithm, to group the one or more deployed APs. The example eigenvectors matrix 622 illustrated in FIG. 6B is merely one example and may include any number of eigenvectors based on the number of desired clusters (e.g., number of floors, number of buildings or sections, etc.).

In this example, compute engine 366 may apply a clustering algorithm on eigenvalues computed from Laplacian matrix 610 to determine how AP nodes 602 in network graph 600 are connected to each other. In this example, compute engine 366 may apply the clustering algorithm on eigenvalues matrix 620 and determine that eigenvalues matrix 620 includes a single eigenvalue of zero (0), which represents one connected component between two densely populated areas of AP nodes 602, e.g., connection between AP group 630 and AP group 632. Compute engine 366 may apply the clustering algorithm of the eigenvalues matrix 620 and determine that the first non-zero eigenvalue (e.g., the spectral gap), 0.8299, indicates that there is almost a separation of the two AP groups. Compute engine 366 may apply the clustering algorithm of the eigenvalues matrix 620 and determine that the second-smallest eigenvalue (e.g., Fiedler value) of 2.0000 represents a minimum graph cut needed to separate the graph into two connected components. In this example, compute engine 366 of clustering module 364 may determine, based on the eigenvalues, that there are two groups of APs, AP group 630 and AP group 632.

Compute engine 366 may also determine a vector (e.g., Fiedler vector) corresponding to the Fiedler value and use the Fiedler vector to create labels for the groups of APs. For example, compute engine 366 may determine the eigenvectors of the second column of the eigenvectors matrix 622 (e.g., eigenvectors 634) correspond to the Fiedler value and uses eigenvectors 634 to determine which side of the graph cut the nodes belong. In this example, AP node 602A, AP node 602B, and AP node 602C belong to AP group 630 because the eigenvectors of these AP nodes have a negative value. Similarly, AP node 602D and AP node 602E belong to AP group 632 because the eigenvectors of these AP nodes have a positive value.

As one example, the administrator may specify, via user interface 310, the value of “k” that may represent the number of floors of a multi-floor structure of a site or the number of buildings of a multi-building site. In this example, the administrator may specify a value of two that represents two floors of the multi-floor structure of site 102A. Compute engine 366 may uniquely assign, based on the k-means clustering algorithm, group information (e.g., a floor number or building number) for each group of APs. In this example, compute engine 366 may assign a first group to AP group 630 (e.g., floor number 1 that is associated with AP nodes 602A-602C) and a second group to AP group 632 (e.g., floor number 2 that is associated with AP nodes 602D-602E).

FIG. 7 is a conceptual diagram illustrating an example group map based on the automatic grouping of the one or more deployed APs, in accordance with one or more techniques of the disclosure. Group map 700 is an example visualization of a floor map of a multi-floor structure. Group map 700 may be generated by group map generator 380 of FIG. 6B based on the automatic grouping of AP nodes 602 of FIGS. 6A and 6B.

In this example, group map 700 includes two groups of APs, e.g., AP group 702 and AP group 704. AP group 702 includes AP node 706A, AP node 706B, and AP node 706C, and similarly, AP group 704 includes AP node 706D and AP node 706E. AP nodes 706A-706C may represent AP nodes 602A-602C grouped within AP group 630 of FIG. 6B and AP nodes 706D-706E may represent AP nodes 602D-602E grouped within AP group 632 of FIG. 6B.

In some examples, group map 700 includes a visualization of the identifiers that are uniquely assigned to AP nodes of APs groups 702, 704. For example, AP nodes 702D-702E may be configured with a first color that indicates AP nodes 702D-702E are on a first floor of the multi-floor structure, and AP nodes 702A-702C may be configured with a second color that indicates AP nodes 702A-702C are on a second floor of the multi-floor structure. In some examples, the AP nodes of each group of APs are configured to display a number or any other label that indicates a group of APs are on a particular floor of the multi-floor structure.

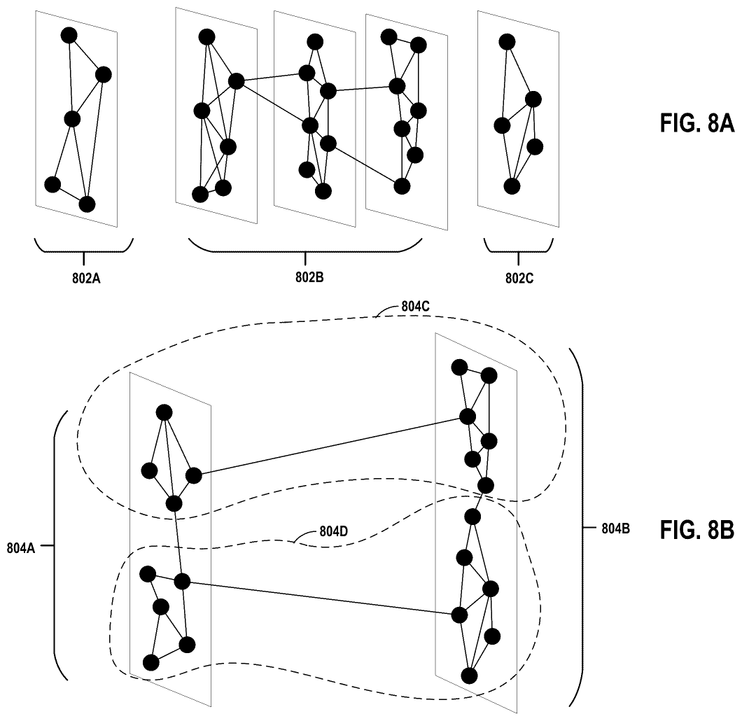

FIGS. 8A-8B illustrate other examples of automatically grouping one or more deployed APs in a wireless network, in accordance with the techniques described in this disclosure. FIGS. 8A-8B are described with respect to NMS 300 of FIG. 3A and clustering module 364 of FIG. 3B. As described herein, clustering module 364 may determine a number of connected components (e.g., groups of connected APs) before clustering the APs. In the example illustrated in FIG. 8A, clustering module 364 may determine (e.g., by applying a breadth first search (BFS) algorithm or other algorithm to the network graph of APs) that there are three connected components 802A-802C (collectively, “connected components 802”). Connected component 802A includes a first group of connected AP nodes, connected component 802B includes a second group of connected AP nodes, and connected component 802C includes a third group of connected AP nodes.

In this example, a connected component 802 (e.g., connected component 802B) may include APs of different floors due to one or more APs of a particular floor detecting radio signals from one or more APs of a different floor (referred to as “bleed-through signals”). This may cause the number of clusters of APs determined by clustering module 364 to not match the number of desired clusters (e.g., number of groups of APs is less than the number of floors). In these examples, clustering module 364 may compare the number of connected components to a value k (e.g., the number of floors of a multi-floor site or the number of buildings of a multi-building site) of the k-means clustering algorithm. If clustering module 364 determines that the number of connected components is less than the value k (which may be indicative that at least one of the connected components 802 includes APs of different floors), clustering module 364 may determine whether each of connected components 802 is an isolated area of AP nodes. To determine if a connected component is an isolated area of AP nodes, clustering module 364 may determine whether the connected component includes an anchor AP node. If a connected component does not have an anchor AP node, clustering module 364 may determine that the connected component is an isolated area of AP nodes (because each cluster, such as a floor, includes at least one anchor AP node and a group of APs that does not include an anchor AP node is thus an isolated area of AP nodes). In this example, clustering module 364 may determine that connected component 802B is an isolated area of AP nodes.

In response to determining connected component 802B is an isolated area of AP nodes, clustering module 364 may compare the number of AP nodes in the isolated area with a threshold (T) that specifies, for example, a presumed (i.e., expected) number of AP nodes for a given cluster (e.g., floor/building). As one example, clustering module 364 may compute a threshold T based on a total number of AP nodes (e.g., total number of APs across all floors) divided by the value k (which is based on a presumption that the number of AP nodes is evenly distributed between the floors). For example, if the total number of AP nodes is fifty (50) and the number of floors is five (5), clustering module 364 may compute a threshold value T of ten (10), which may indicate that the expected number of AP nodes on each floor is ten. If the number of AP nodes in the isolated area is greater than the threshold M, clustering module 364 may determine that the isolated cluster may include AP nodes of different floors. In this example, if clustering module 364 determines that the number of AP nodes in the isolated area is greater than the threshold, clustering module 364 may apply a spectral clustering algorithm to the isolated area to make a graph cut to separate the isolated area of AP nodes into separate groups. The number of cuts (N) to the isolated area may be computed, for example, based on a number of AP nodes in the isolated area divided by the threshold T (rounded up if the computed number of cuts to the isolated area is a decimal number). For example, assume that connected component 802B includes twenty (20) AP nodes and the threshold T that is specified with an expected number of AP nodes for each floor is ten (10). In this example, clustering module 364 may apply two (2) graph cuts to the isolated area of AP nodes (e.g., twenty AP nodes in connected component 802B divided by ten AP nodes expected on each floor). In response to making the graph cuts to the isolated area of AP nodes, clustering module 364 may assign (or prompt a client to assign) each cut with an anchor AP node to cause the cuts to no longer be considered as isolated areas of AP nodes (such that each floor may have an assigned anchor AP node). Clustering module 364 may then generate a new adjacency matrix with the connected components (with the isolated areas of AP nodes removed) to again form clusters of one or more AP nodes of the wireless network (based on the value k that may represent the number of floors of a multi-floor structure of a site or the number of buildings of a multi-building site), in accordance with the clustering algorithm as described above in FIGS. 6A-6B.

In the example illustrated in FIG. 8B, clustering module 364 may determine (e.g., by applying a BFS algorithm or other algorithm to the network graph of APs) that there are four connected components 804A-804D (collectively, “connected components 804”). In the example illustrated in FIG. 8B, connected component 804A includes a first group of connected AP nodes, connected component 804B includes a second group of connected AP nodes, connected component 804C includes a third group of connected AP nodes, and connected component 804D includes a fourth group of connected AP nodes. In this example, clustering module 364 may determine that the number of connected components is greater than the value k (e.g., greater than the number of floors of a multi-floor site or the number of buildings of a multi-building site) of the k-means clustering algorithm. In the example of FIG. 8B, clustering module 364 may determine that the number of connected components is greater than the value k (which is a particular number of floors (two) in this example), which may be indicative that at least one of the connected components 804 includes APs of different floors. Based on the determination that the number of connected components is greater than the value k, clustering module 364 may determine whether each of the connected components 804 is an isolated area of AP nodes. Similar to the example in FIG. 8A described above, clustering module 364 may determine whether the connected component is an isolated area of AP nodes based on whether the connected component includes an anchor AP node. In this example, clustering module 364 may determine that connected components 804C and 804D are isolated areas of AP nodes. In response to determining that connected components 804C and 804D are isolated areas of AP nodes, clustering module 364 may, for each of the isolated areas of AP nodes, compare the number of AP nodes in a given isolated area with a threshold T that specifies, for example, the total number of APs (of a site) divided by the total number of connected components. If the total number of APs of the given isolated area (e.g., connected component 804C) is greater than the threshold T, clustering module 364 may apply a spectral clustering algorithm to the isolated area to make a graph cut (based on a number of cuts N computed, for example, based on a number of AP nodes in the isolated area divided by the threshold T) to separate the isolated area of AP nodes into separate groups, and may assign (or prompt a client to assign) each cut with an anchor AP node to cause the cuts to no longer be considered as isolated areas of AP nodes.

Clustering module 364 may then generate a new adjacency matrix with the connected components (with the isolated areas of AP nodes removed) to again form clusters of one or more APs of the wireless network based on a new value k′ that specifies the number of cuts to the one or more APs of the wireless network. As one example, clustering module 364 may compute a value k′ based on a value of k that may specify a number of leftover clusters (e.g., remaining clusters with isolated areas of AP nodes removed) incremented by a number (Xᵢ) that is computed, for each of the connected components, based on the number of AP nodes in a given connected component (Mᵢ) divided by the threshold T (the total number of APs (of a site) divided by the total number of connected components). The value k′ therefore may be represented as k′=k+Xᵢ+Xᵢ₊₁ . . . Xᵢ₊ₙ, where k is the leftover clusters, Xᵢ₊ₙ is a value computed based on the number of AP nodes in a given connected component M divided by the threshold T (rounded to the whole number if the computed number of cuts to the isolated area is a decimal number), and k′ represents the number of cuts to be made to the isolated area of AP nodes. For example, assume that connected component 804A includes twenty-five (25) AP nodes, connected component 804B includes thirty (30) AP nodes, connected component 804C includes sixty-two (62) AP nodes, connected component 804D includes forty-three (43) AP nodes, and the threshold T specifying the total number of APs (of a site) divided by the total number of connected components as twenty (20). In this example, clustering module 364 may compute a value for k′ as nine (9) based on a value of k (for the leftover clusters) incremented by one (e.g., number of AP nodes in connected component 804A divided by threshold T rounded to the whole number), further incremented by one (e.g., number of AP nodes in connected component 804B divided by threshold T rounded to the whole number), further incremented by three (e.g., number of AP nodes in connected component 804C divided by threshold T rounded to the whole number), further incremented by two (e.g., number of AP nodes in connected component 804D divided by threshold T rounded to the whole number). Clustering module 364 may then apply the spectral clustering algorithm using k′ to again form clusters of the one or more AP nodes of the wireless network.

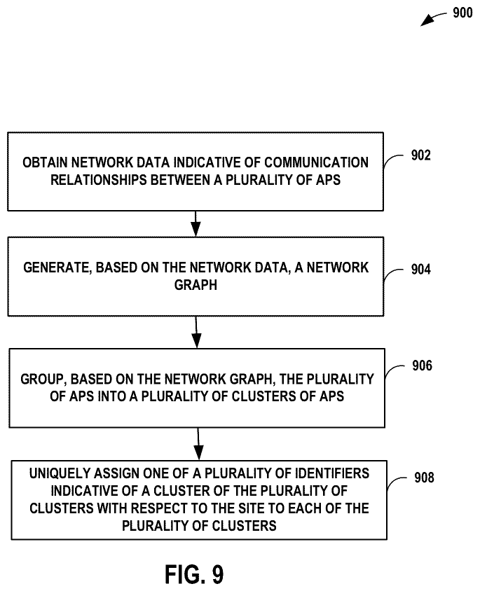

FIG. 9 is a flowchart of an example process 900 by which a computing device automatically groups one or more deployed APs that is used to learn the wireless network environment, in accordance with one or more techniques of the disclosure. In some examples, the computing device includes one or more processor(s) of a network management system 300 and/or an AP grouping module 342, such as processor(s) 306 of NMS 300 as shown in FIG. 3A.

In the example of FIG. 9, the computing device obtains network data indicative of the communication relationships between a plurality of APs (902). For example, NMS 300 obtains network data, such as RTT and/or RSSI data from APs 142. Based on the network data, the computing device generates a network graph indicative of neighboring relationships between the plurality of APs (904). The computing device groups the plurality of APs into a plurality of clusters based on the network graph (906). For example, NMS 300 generates a matrix representation (e.g., Laplacian matrix) of the network graph. NMS 300 computes eigenvalues and eigenvectors based on the matrix representation of the network graph and applies a spectral clustering algorithm (e.g., k-means clustering algorithm) to the eigenvalues and eigenvectors. Each of the resulting clusters output by the k-means clustering algorithm may represent, for example, a densely populated area of APs that have a strong connection to each other, and thus may represent a group of APs of a particular floor (or a particular building).

In some examples, NMS 300 may determine whether a number of connected components does not match a predetermined number of clusters, k (e.g., predetermined number of floors). If NMS 300 determines that the number of connected components is less than the value k, NMS 300 may determine whether each of the connected components includes an anchor AP node, which is indicative of an isolated area of APs. If a connected component does not include an anchor node, NMS 300 may compare the number of AP nodes in the connected component determined to be an isolated area with a threshold, such as a threshold computed based on a total number of AP nodes of the site divided by the value k (which is based on a presumption that the number of AP nodes is evenly distributed between the floors). If NMS 300 determines that the number of AP nodes in the isolated area is greater than the threshold, NMS 300 may apply a spectral clustering algorithm to the isolated area and make a graph cut to separate the isolated area of AP nodes into one or more separate groups of APs and tag each of the one or more separate groups of APs with an anchor AP node (to cause the cuts to no longer be considered as isolated areas of AP nodes), and generate a new adjacency matrix with the isolated areas of AP nodes removed from the adjacency matrix. NMS 300 may apply the spectral clustering algorithm with the new adjacency matrix to again form clusters of one or more APs of the wireless network.

In some examples, if NMS 300 determines that the number of connected components is greater than the value k, NMS 300 may determine whether each of the connected components includes an anchor AP node, which is indicative of an isolated area of APs. If a connected component does not include an anchor node, NMS 300 may compare the number of AP nodes in the connected component determined to be an isolated area with a threshold, such as a threshold computed based on a total number of AP nodes of the site divided by the total number of connected components. If NMS 300 determines that the number of AP nodes of a given isolated area is greater than the threshold, NMS 300 may apply a spectral clustering algorithm to the isolated area and make a graph cut to separate the isolated area of AP nodes into one or more separate groups of APs and assign each of the one or more separate groups of APs with an anchor AP node to cause the cuts to no longer be considered as isolated areas. NMS 300 may then generate a new adjacency matrix with the connected components (with the isolated areas of AP nodes removed) to again form clusters of one or more APs of the wireless network. For example, NMS 300 may compute a new value k′ that specifies the number of cuts to the one or more AP nodes of the wireless network. As one example, NMS 300 may compute a value k′ based on a value of k that may specify a number of leftover clusters (e.g., remaining clusters with isolated areas of AP nodes removed) incremented by a number (Xᵢ) that is computed, for each of the connected components, based on the number of AP nodes in a given connected component (Mᵢ) divided by the threshold T (the total number of APs (of a site) divided by the total number of connected components). NMS 300 may then apply the spectral clustering algorithm using k′ to again form clusters of the one or more AP nodes of the wireless network. NMS 300 uniquely assigns an identifier of a plurality of identifiers indicative of a cluster of the plurality of clusters with respect to the site to each of the plurality of clusters (908). The output by the k-means clustering algorithm may uniquely assign an identifier indicative of the group of APs with respect to a site (e.g., a specific floor number of a plurality of floor numbers). In some examples, the computing device may use the group information to determine the location of APs of each group of APs. For example, as described above, AP location module 344 of NMS 300 may automatically determine the x, y (and in some examples, z) coordinate locations of each AP of each group of APs at a site in a global coordinate system for the site.

The techniques described herein may be implemented using software, hardware and/or a combination of software and hardware. Various examples are directed to apparatus, e.g., mobile nodes, mobile wireless terminals, base stations, e.g., access points, communications system. Various examples are also directed to methods, e.g., method of controlling and/or operating a communications device, e.g., wireless terminals (UEs), base stations, control nodes, access points and/or communications systems. Various examples are also directed to non-transitory machine, e.g., computer, readable medium, e.g., ROM, RAM, CDs, hard discs, etc., which include machine readable instructions for controlling a machine to implement one or more steps of a method.

It is understood that the specific order or hierarchy of steps in the processes disclosed is an example of example approaches. Based upon design preferences, it is understood that the specific order or hierarchy of steps in the processes may be rearranged while remaining within the scope of the present disclosure. The accompanying method claims present elements of the various steps in a sample order and are not meant to be limited to the specific order or hierarchy presented.

In various examples devices and nodes described herein are implemented using one or more modules to perform the steps corresponding to one or more methods, for example, signal generation, transmitting, processing, and/or receiving steps. Thus, in some examples various features are implemented using modules. Such modules may be implemented using software, hardware or a combination of software and hardware. In some examples each module is implemented as an individual circuit with the device or system including a separate circuit for implementing the function corresponding to each described module. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various examples are directed to a machine-readable medium e.g., a non-transitory computer readable medium, including machine executable instructions for causing a machine, e.g., processor and associated hardware, to perform one or more of the steps of the above-described method(s). Some examples are directed to a device including a processor configured to implement one, multiple, or all of the steps of one or more methods of the one example aspect.

In some examples, the processor or processors, e.g., CPUs, of one or more devices, e.g., communications devices such as wireless terminals (UEs), and/or access nodes, are configured to perform the steps of the methods described as being performed by the devices. The configuration of the processor may be achieved by using one or more modules, e.g., software modules, to control processor configuration and/or by including hardware in the processor, e.g., hardware modules, to perform the recited steps and/or control processor configuration. Accordingly, some but not all examples are directed to a communications device, e.g., user equipment, with a processor which includes a module corresponding to each of the steps of the various described methods performed by the device in which the processor is included. In some but not all examples a communications device includes a module corresponding to each of the steps of the various described methods performed by the device in which the processor is included. The modules may be implemented purely in hardware, e.g., as circuits, or may be implemented using software and/or hardware or a combination of software and hardware.

Some examples are directed to a computer program product comprising a computer-readable medium comprising code for causing a computer, or multiple computers, to implement various functions, steps, acts and/or operations, e.g. one or more steps described above. In some examples, the computer program product can, and sometimes does, include different code for each step to be performed. Thus, the computer program product may, and sometimes does, include code for each individual step of a method, e.g., a method of operating a communications device, e.g., a wireless terminal or node. The code may be in the form of machine, e.g., computer, executable instructions stored on a computer-readable medium such as a RAM (Random Access Memory), ROM (Read Only Memory) or other type of storage device. In addition to being directed to a computer program product, some examples are directed to a processor configured to implement one or more of the various functions, steps, acts and/or operations of one or more methods described above. Accordingly, some examples are directed to a processor, e.g., CPU, graphical processing unit (GPU), digital signal processing (DSP) unit, etc., configured to implement some or all of the steps of the methods described herein. The processor may be for use in, e.g., a communications device or other device described in the present application.

Numerous additional variations on the methods and apparatus of the various examples described above will be apparent to those skilled in the art in view of the above description. Such variations are to be considered within the scope of this disclosure. The methods and apparatus may be, and in various examples are, used with BLE, LTE, CDMA, orthogonal frequency division multiplexing (OFDM), and/or various other types of communications techniques which may be used to provide wireless communications links between access nodes and mobile nodes. In some examples the access nodes are implemented as base stations which establish communications links with user equipment devices, e.g., mobile nodes, using OFDM and/or CDMA. In various examples the mobile nodes are implemented as notebook computers, personal data assistants (PDAs), or other portable devices including receiver/transmitter circuits and logic and/or routines, for implementing the methods.

In the detailed description, numerous specific details are set forth in order to provide a thorough understanding of some examples. However, it will be understood by persons of ordinary skill in the art that some examples may be practiced without these specific details. In other instances, well-known methods, procedures, components, units and/or circuits have not been described in detail so as not to obscure the discussion.

Some examples may be used in conjunction with various devices and systems, for example, a User Equipment (UE), a Mobile Device (MD), a wireless station (STA), a wireless terminal (WT), a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some examples may be used in conjunction with devices and/or networks operating in accordance with existing Wireless-Gigabit-Alliance (WGA) specifications (Wireless Gigabit Alliance, Inc. WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for Information Technology—Telecommunications and Information Exchange Between Systems Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 December, 2012); IEEE-802.11REVmc (“IEEE 802.11-REVmc™/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”); IEEE802.11-ay (P802.11ay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHz)), IEEE 802.11-2016 (i.e., IEEE 802.11mc) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.5, August 2014) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, or operate using any one or more of the above protocols, and the like.

Some examples may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some examples may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE advanced, Enhanced Data rates for GSM Evolution (EDGE), or the like. Other examples may be used in various other devices, systems and/or networks.

Some demonstrative examples may be used in conjunction with a WLAN (Wireless Local Area Network), e.g., a Wi-Fi network. Other examples may be used in conjunction with any other suitable wireless communication network, for example, a wireless area network, a “piconet”, a WPAN, a WVAN, and the like.

Some examples may be used in conjunction with a wireless communication network communicating over a frequency band of 2.4 Ghz, 5 GHz and/or 60 GHz. However, other examples may be implemented utilizing any other suitable wireless communication frequency band(s), for example, an Extremely High Frequency (EHF) band (the millimeter wave (mmWave) frequency band), e.g., a frequency band within the frequency band of between 20 GhH and 300 GHz, a WLAN frequency band, a WPAN frequency band, a frequency band according to the WGA specification, and the like.

While the above provides just some simple examples of the various device configurations, it is to be appreciated that numerous variations and permutations are possible. Moreover, the technology is not limited to any specific channels, but is generally applicable to any frequency range(s)/channel(s). Moreover, and as discussed, the technology may be useful in the unlicensed spectrum.

Although examples are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although examples are not limited in this regard, the terms “plurality” and “a plurality” as used herein may include, for example, “multiple” or “two or more.” The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The examples have been described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the examples illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links, including any communications channel(s)/elements/lines connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the examples described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The examples are described in relation to enhanced communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The example systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

While the above-described flowcharts have been discussed in relation to a particular sequence of events, it should be appreciated that changes to this sequence can occur without materially effecting the operation of the example(s). Additionally, the example techniques illustrated herein are not limited to the specifically illustrated examples but can also be utilized with the other examples and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, IEEE 802.11me, Wi-Fi, LTE, 4G, Bluetooth®, WirelessHD, WiGig, WiGi, 3GPP, Wireless LAN, WiMAX, DensiFi SIG, Unifi SIG, 3GPP LAA (licensed-assisted access), and the like.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the examples is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed techniques may be readily implemented in software and/or firmware that can be stored on a storage medium to improve the performance of a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there have at least been provided systems and methods for enhancing and improving conversational user interface. Many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

What is claimed is:

1. A system comprising:
a plurality of access point devices (APs) configured to provide a wireless network at a site; and
a computing device implementing a network management system (NMS) that manages the plurality of APs, the computing device comprising:
one or more processors:
a memory comprising instructions that when executed by the one or more processors, cause the one or more processors to:
obtain network data indicative of communication relationships between the plurality of APs;
generate, based on the network data, a network graph;
group, based on the network graph, the plurality of APs into a plurality of clusters of APs; and
uniquely assign, to each of the plurality of clusters, an identifier of a plurality of identifiers that is indicative of a cluster of the plurality of clusters with respect to the site.

2. The system of claim 1, wherein to group the plurality of APs into the plurality of clusters, the one or more processors are further configured to:
generate a Laplacian matrix based on the network graph, wherein the Laplacian matrix is generated based on a difference between a degree matrix including information of a degree of each node in the network graph and an adjacency matrix including information of an adjacency of nodes in the network graph; and
group, based on applying a k-means clustering algorithm to the Laplacian matrix, the plurality of APs into k clusters based on the neighbor relationships between the plurality of APs.

3. The system of claim 2, wherein the adjacency matrix includes weighted values indicative of an amount of the adjacency of nodes in the network graph.

4. The system of claim 2, wherein the site includes a multi-floor structure, wherein k is a number of floors of the multi-floor structure, and wherein each of the k clusters represents a cluster of APs of a particular floor of the k number of floors of the multi-floor structure.

5. The system of claim 2, wherein the site includes a multi-building site, wherein k is a number of buildings of the multi-building site, and wherein each of the k clusters represents a cluster of APs of a particular building of the k number of buildings of the multi-building site.

6. The system of claim 1, wherein the instructions further cause the one or more processors to:
generate the network graph indicative of neighbor relationships between the plurality of APs based on received signal strength indicator (RSSI) values of wireless signals transmitted between the plurality of APs.

7. The system of claim 1, wherein the identifier of the plurality of identifiers comprises one or more of:
a number representing a particular floor of a multi-floor structure of the site; a color representing a particular floor of a multi-floor structure of the site;
a label representing a particular floor of a multi-floor structure of the site;
a number representing a particular building of a multi-building site;
a color representing a particular building of a multi-building site; or
a label representing a particular building of a multi-building site.

8. The system of claim 1, wherein the one or more processors are further configured to:
determine a number of connected components, wherein each of the connected components comprises a group of connected APs;
comparing the number of connected components to a first threshold, wherein the first threshold comprises a predetermined number of clusters of APs;
in response to determining that the number of connected components is less than the first threshold, determining whether the connected components are isolated areas of APs based on determining whether the connected components do not include an anchor AP;
in response to determining that at least one connected component of the connected components does not include the anchor AP and is an isolated area of APs, compare a number of APs in the isolated area of APs to a second threshold, wherein the second threshold comprises a total number of APs of the site divided by the predetermined number of clusters of APs;
in response to determining that the number of APs in the isolated area of APs is greater than the second threshold, perform a graph cut in the network graph to separate the isolated area of APs into one or more separate groups of APs and tag each of the one or more separate groups of APs with an anchor AP; and
group the plurality of APs into the plurality of clusters without the one or more separate groups of APs.

9. The system of claim 1, wherein the one or more processors are further configured to:
determine a number of connected components, wherein each of the connected components comprises a group of connected APs;
comparing the number of connected components to a first threshold, wherein the first threshold comprises a predetermined number of clusters;
in response to determining that the number of connected components is greater than the first threshold, determining whether the connected components are isolated areas of APs based on determining whether the connected components do not include an anchor AP;
in response to determining that at least one connected component of the connected components does not include the anchor AP and is an isolated area of APs, compare a number of APs in the isolated area of APs to a second threshold, wherein the second threshold comprises a total number of APs of the site divided by the predetermined number of clusters of APs;
in response to determining that the number of APs in the isolated area of APs is greater than the threshold, perform a graph cut in the network graph to separate the isolated area of APs into one or more groups of APs and tag each cut with an anchor AP; and
group the plurality of APs into the plurality of clusters without the one or more separated groups of APs.

10. A method comprising:
obtaining, by a computing device implementing a network management system (NMS) that manages a plurality of access point devices (APs) configured to provide a wireless network at a site, network data indicative of communication relationships between the plurality of APs;
generating, by the computing device and based on the network data, a network graph;
grouping, by the computing device and based on the network graph, the plurality of APs into a plurality of clusters of APs; and
uniquely assigning, by the computing device and to each of the plurality of clusters, an identifier of a plurality of identifiers that is indicative of a cluster of the plurality of clusters with respect to the site.

11. The method of claim 10, wherein grouping the plurality of APs into the plurality of clusters comprises:
generating, by the computing device, a Laplacian matrix based on the network graph, wherein the Laplacian matrix is generated based on a difference between a degree matrix including information of a degree of each node in the network graph and an adjacency matrix including information of an adjacency of nodes in the network graph; and
grouping, by the computing device and based on applying a k-means clustering algorithm to the Laplacian matrix, the plurality of APs into k clusters based on the neighbor relationships between the plurality of APs.

12. The method of claim 11, wherein the adjacency matrix includes weighted values indicative of an amount of the adjacency of nodes in the network graph.

13. The method of claim 11, wherein the site includes a multi-floor structure, wherein k is a number of floors of the multi-floor structure, and wherein each of the k clusters represents a cluster of APs of a particular floor of the k number of floors of the multi-floor structure.

14. The method of claim 11, wherein the site includes a multi-building site, wherein k is a number of buildings of the multi-building site, and wherein each of the k clusters represents a cluster of APs of a particular building of the k number of buildings of the multi-building site.

15. The method of claim 10, further comprising:
generating, by the computing device, the network graph indicative of neighbor relationships between the plurality of APs based on received signal strength indicator (RSSI) values of wireless signals transmitted between the plurality of APs.

16. The method of claim 10, wherein the identifier of the plurality of identifiers comprises one or more:
a number representing a particular floor of a multi-floor structure of the site;
a color representing a particular floor of a multi-floor structure of the site;
a label representing a particular floor of a multi-floor structure of the site;
a number representing a particular building of a multi-building site;
a color representing a particular building of a multi-building site; or
a label representing a particular building of a multi-building site.

17. The method of claim 10, further comprising:
determining, by the computing device, a number of connected components, wherein each of the connected components comprises a group of connected APs;
comparing, by the computing device, the number of connected components to a first threshold, wherein the first threshold comprises a predetermined number of clusters of APs;
in response to determining that the number of connected components is less than the first threshold, determining, by the computing device, whether the connected components are isolated areas of APs based on determining whether the connected components do not include an anchor AP;
in response to determining that at least one connected component of the connected components does not include the anchor AP and is an isolated area of APs, comparing, by the computing device, a number of APs in the isolated area of APs to a second threshold, wherein the second threshold comprises a total number of APs of the site divided by the predetermined number of clusters of APs;
in response to determining that the number of APs in the isolated area of APs is greater than the second threshold, performing, by the computing device, a graph cut in the network graph to separate the isolated area of APs into one or more separate groups of APs and tag each of the one or more separate groups of APs with an anchor AP; and
group the plurality of APs into the plurality of clusters without the one or more separate groups of APs.

18. The method of claim 10, further comprising:
determining, by the computing device, a number of connected components, wherein each of the connected components comprises a group of connected APs;
comparing, by the computing device, the number of connected components to a first threshold, wherein the first threshold comprises a predetermined number of clusters;
in response to determining that the number of connected components is greater than the first threshold, determining, by the computing device, whether the connected components are isolated areas of APs based on determining whether the connected components do not include an anchor AP;
in response to determining that at least one connected component of the connected components does not include the anchor AP and is an isolated area of APs, comparing, by the computing device, a number of APs in the isolated area of APs to a second threshold, wherein the second threshold comprises a total number of APs of the site divided by the number of connected components;
in response to determining that the number of APs in the isolated area of APs is greater than the second threshold, performing, by the computing device, a graph cut in the network graph to separate the isolated area of APs into one or more separate groups of APs and tag each of the one or more separate groups of APs with an anchor AP; and
grouping, by the computing device, the plurality of APs into the plurality of clusters without the one or more separate groups of APs.

19. Non-transitory computer-readable storage media comprising instructions that, when executed, cause one or more processors to:
obtain network data indicative of communication relationships between the plurality of APs;
generate, based on the network data, a network graph;
group, based on the network graph, the plurality of APs into a plurality of clusters of APs; and
uniquely assign, to each of the plurality of clusters, an identifier of a plurality of identifiers that is indicative of a cluster of the plurality of clusters with respect to the site.

20. The non-transitory computer-readable storage media of claim 19, wherein to group the plurality of APs into the plurality of clusters, the instructions further cause the one or more processors to:
generate a Laplacian matrix based on the network graph, wherein the Laplacian matrix is generated based on a difference between a degree matrix including information of a degree of each node in the network graph and an adjacency matrix including information of an adjacency of nodes in the network graph; and
group, based on applying a k-means clustering algorithm to the Laplacian matrix, the plurality of APs into k clusters based on the neighbor relationships between the plurality of APs.
